(19) United States
(12) Patent Application Publication
(10) Pub. No.: US 2024/0137179 A1
(43) Pub. Date: Apr. 25, 2024

(54) METHOD AND APPARATUS FOR SELECTING DEFAULT BEAM AND PATHLOSS REFERENCE SIGNAL FOR TRANSMISSION OF UPLINK CONTROL INFORMATION IN WIRELESS COMMUNICATION SYSTEMS

(71) Applicant: Samsung Electronics Co., Ltd., Gyeonggi-do (KR)

(72) Inventors: Ameha Tsegaye ABEBE, Gyeonggi-do (KR); Dhivagar BASKARAN, Bangalore (IN); Youngrok JANG, Gyeonggi-do (KR); Younsun KIM, Gyeonggi-do (KR); Seongmok LIM, Gyeonggi-do (KR); Hyoungju JI, Gyeonggi-do (KR)

(21) Appl. No.: 18/547,615

(22) PCT Filed: Mar. 13, 2022
(86) PCT No.: PCT/KR2022/003545

§ 371 Date: Aug. 22, 2023

(30) Foreign Application Priority Data
Mar. 18, 2021 (IN) 202131011740

(51) Int. Cl. H04L 5/00

(52) U.S. Cl. CPC H04L 5/0051; H04L 5/0053; H04L 5/0091

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The present disclosure relates to the field of 5G communication networks and more particularly to the behaviour of user equipment (UE) towards selecting a default beam and pathloss reference signal (PL-RS) for the transmission of physical uplink control channel (PUCCH).

### TECHNICAL FIELD

The present disclosure relates to the field of 5G communication networks and more particularly to the behaviour of user equipment (UE) towards selecting a default beam and pathloss reference signal (PL-RS) for the transmission of physical uplink control channel (PUCCH).

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

As a part of further enhancement of the existing Rel.16 of the 5^{th} generation (5G) new radio (NR) mobile communication system, in Rel. 17, control and data channel transmissions are being redesigned for better reliability and performance it can be referred to the 3GPP RANI work item document (WID) for Rel-17 further-enhanced multiple input multiple output (FeMIMO). One such enhancement is multiple transmission reception point (mTRP)-based reliability enhancement for physical downlink control channel (PDCCH). The enhancement focuses on improving the reliability of PDCCH by transmitting the same downlink control information (DCI) from multiple TRPs (mTRP) via different multiplexing schemes. Similarly, further enhancement on the reliability of uplink control information (UCI) transmission is being considered by allowing a UE to transmit its UCI towards multiple TRPs over repeated (in time domain) physical uplink control channel (PUCCH) transmissions.

### DISCLOSURE OF INVENTION

### Technical Problem

The principal object of the embodiments herein is to disclose methods and apparatus for selecting the default beam, or the transmitter spatial filter, upon transmission of PUCCH in communication networks, wherein the communication network is at least one of the Fifth Generation (5G) standalone network and a 5G non-standalone (NAS) network.

Another object of the embodiments herein is to disclose methods and systems for selecting the default PLRS for measurement of pathloss upon transmission of PUCCH in 5G communication network.

Another object of this embodiment herein is to disclose methods and apparatus for selecting default beam and default PLRS upon PUCCH repetitions intended for multiple transmit receive points (mTRP).

### Solution to Problem

In accordance with an aspect of the disclosure, a terminal in a communication system is provided. The terminal includes a transceiver; and a controller configured to: receive, from a base station, a higher layer parameter enabling a default beam and a default pathloss reference signal (RS) for a physical uplink control channel (PUCCH), identify a spatial relation for the PUCCH, transmit, to the base station, the PUCCH based on the spatial relation, wherein the spatial relation for the PUCCH is associated with a transmission configuration indication (TCI) state of a control resource set (CORESET) with the lowest ID on an active downlink (DL) BWP, and wherein, in case that the CORESET corresponds to more than one activated TCI state, the spatial relation for the PUCCH is associated with a first TCI state among the more than one activated TCI state.

In accordance with another aspect of the disclosure, a method performed by a terminal in a communication system is provided. The method includes receiving, from a base station, a higher layer parameter enabling a default beam and a default pathloss reference signal (RS) for a physical uplink control channel (PUCCH), identifying a spatial relation for the PUCCH, transmitting, to the base station, the PUCCH based on the spatial relation, wherein the spatial relation for the PUCCH is associated with a transmission configuration indication (TCI) state of a control resource set (CORESET) with the lowest ID on an active downlink (DL) BWP, and wherein, in case that the CORESET corresponds to more than one activated TCI state, the spatial relation for the PUCCH is associated with a first TCI state among the more than one activated TCI state.

In accordance with another aspect of the disclosure, a base station is provided. The base station in a communication system includes a transceiver; and a controller configured to: transmit, to a terminal, a higher layer parameter enabling a default beam and a default pathloss reference signal (RS) for a physical uplink control channel (PUCCH), and receive, from the terminal, the PUCCH based on a spatial relation for the PUCCH, wherein the spatial relation for the PUCCH is associated with a transmission configuration indication (TCI) state of a control resource set (CORESET) with the lowest ID on an active downlink (DL) BWP, and wherein, in case that the CORESET corresponds to more than one activated TCI state, the spatial relation for the PUCCH is associated with a first TCI state among the more than one activated TCI state.

In accordance with another aspect of the disclosure, a method performed by a base station in a communication system is provided. The method includes transmitting, to a terminal, a higher layer parameter enabling a default beam and a default pathloss reference signal (RS) for a physical uplink control channel (PUCCH), and receiving, from the terminal, the PUCCH based on a spatial relation for the PUCCH, wherein the spatial relation for the PUCCH is associated with a transmission configuration indication (TCI) state of a control resource set (CORESET) with the lowest ID on an active downlink (DL) BWP, and wherein, in case that the CORESET corresponds to more than one activated TCI state, the spatial relation for the PUCCH is associated with a first TCI state among the more than one activated TCI state.

### Advantageous Effects of Invention

The present disclosure provides method and apparatus for selecting default beam and pathloss reference signal for transmission of uplink control information in wireless communication systems.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates an uplink/downlink time-frequency area transmission structure in an NR system according to an embodiment of disclosure;

FIG. 2 illustrates an example of the configuration of a bandwidth part (BWP) in a wireless communication system according to an embodiment of the disclosure;

FIG. 3 illustrates an example of the configuration of a control resource set of a downlink control channel in a wireless communication system according to an embodiment of the disclosure;

FIG. 4 illustrates a structure of a downlink control channel in an NR system according to an embodiment of the disclosure;

FIG. 5 illustrates a downlink or uplink scheduling method and a resource area in an NR system according to an embodiment of the disclosure;

FIG. 6 illustrates a process of beam configuration and activation of a PDCCH according to an embodiment of the disclosure;

FIG. 7 illustrates a process of beam configuration and activation of a PDSCH according to an embodiment of the disclosure;

FIG. 8 illustrates a flowchart for the 5G release 16 communication network (Rel. 16) new radio (NR)-based beam (spatial setting) acquisition for PUCCH transmission;

FIG. 9 illustrates a flowchart for the 5G release 16 communication network (Rel. 16) new radio (NR)-based PL-RS acquisition for PUCCH transmission;

FIG. 10 illustrates an example of sequential and cyclic beam mapping pattern for PUCCH repetition towards mTRP;

FIG. 11 illustrates an example of SFN and non-SFN-based PDCCH Transmission where two PDCCH are received in the TDM and FDM manner from two TRPs;

FIG. 12 illustrates a flowchart for the UE-side process of acquiring a default beam and PLRS for the transmission of PUCCH in the disclosed embodiments;

FIG. 13 illustrates a flowchart for the gNB-side process of acquiring a default beam and PLRS for the transmission of PUCCH in the disclosed embodiments;

FIG. 14 illustrates a possible realization of Embodiment I 3 wherein an example is given based on SFNed transmission from two TRPs;

FIG. 15 illustrates a possible realization of Embodiment II 7.1 in which an example is given based on PDCCH transmission from two TRPs;

FIG. 16 illustrates an SFNed PDCCH transmission from M TRPs and PUCCH transmission with N default beams;

FIG. 17 is a block diagram illustrating a structure of a base station according to an embodiment of the disclosure; and

FIG. 18 is a block diagram illustrating a structure of a terminal according to an embodiment of the disclosure.

### MODE FOR THE INVENTION

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

The abbreviations used in the specification hereinafter have the following meanings unless otherwise specified.

2D Two-dimensional

ACK Acknowledgement

AoA Angle of arrival

AoD Angle of departure

ARQ Automatic Repeat Request

BW Bandwidth

CDM Code Division Multiplexing

CP Cyclic Prefix

C-RNTI Cell RNTI

CRS Common Reference Signal

CRI CSI-RS resource indicator

CSI Channel State Information

CSI-RS Channel State Information Reference Signal

CQI Channel Quality Indicator

DCI Downlink Control Information

dB deciBell

DL Downlink

DL-SCH DL Shared Channel

DMRS Demodulation Reference Signal

eMBB Enhanced mobile broadband

eNB eNodeB (base station)

FDD Frequency Division Duplexing

FDM Frequency Division Multiplexing

FFT Fast Fourier Transform

HARQ Hybrid ARQ

IFFT Inverse Fast Fourier Transform

LAA License assisted access

LBT Listen before talk

LTE Long-term Evolution

MIMO Multi-input multi-output

mMTC massive Machine Type Communications

MTC Machine Type Communications

MU-MIMO Multi-user MIMO

NACK Negative ACKnowledgement

NW Network

OFDM Orthogonal Frequency Division Multiplexing

PBCH Physical Broadcast Channel

PDCCH Physical Downlink Control Channel

PDSCH Physical Downlink Shared Channel

PHY Physical layer

PRB Physical Resource Block

PMI Precoding Matrix Indicator

PSS Primary Synchronization Signal

PUCCH Physical Uplink Control Channel

PUSCH Physical Uplink Shared Channel

QoS Quality of service

RAN Radio access network

RAT Radio access technology

RB Resource Block

RE Resource Element

RI Rank Indicator

RRC Radio Resource Control

RS Reference Signals

RSRP Reference Signal Received Power

SDM Space Division Multiplexing

SINR Signal to Interference and Noise Ratio

SPS Semi-Persistent Scheduling

SRS Sounding RS

SF Subframe

SSS Secondary Synchronization Signal

SU-MIMO Single-user MIMO

TDD Time Division Duplexing

TDM Time Division Multiplexing

TB Transport Block

TP Transmission point

TTI Transmission time interval

UCI Uplink Control Information

UE User Equipment

UL Uplink

UL-SCH UL Shared Channel

URLL Ultra-reliable low-latency

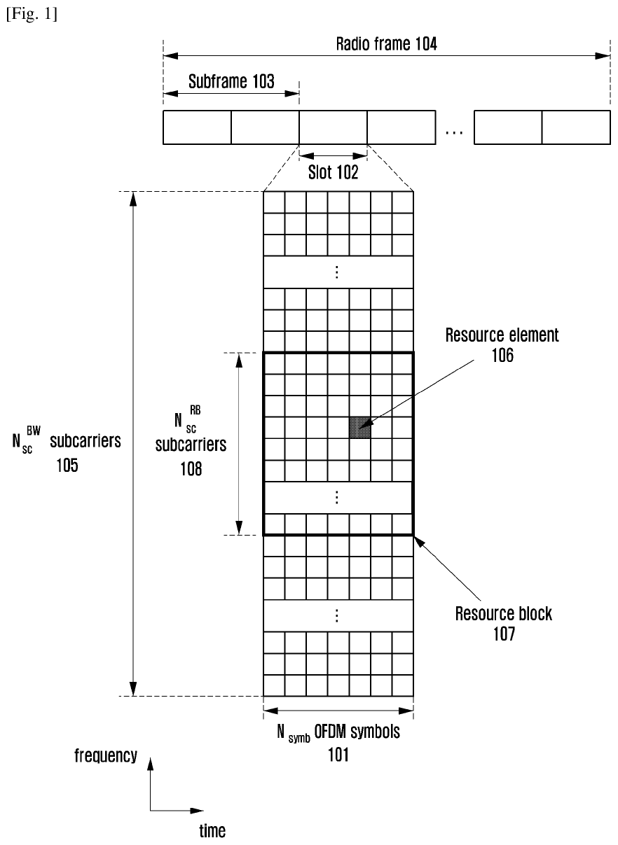

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. When it is determined that a detailed description of known functions or configurations related to the disclosure may obscure the gist of the disclosure, the detailed description thereof will be omitted. Further, the following terminologies are defined in consideration of the functions in the disclosure and may be construed in different ways by the intention or practice of users and operators. Therefore, the definitions thereof should be construed based on the contents throughout the specification.

Various advantages and features of the disclosure and methods accomplishing the same will become apparent from the following detailed description of embodiments with reference to the accompanying drawings. However, the disclosure is not limited to the embodiments disclosed herein but may be implemented in various forms. The embodiments have made disclosure complete and are provided so that those skilled in the art can easily understand the scope of the disclosure. Therefore, the disclosure will be defined by the scope of the appended claims. Like reference numerals throughout the description denote like elements.

Hereinafter, embodiments of the disclosure will be described in detail with reference to the accompanying drawings.

In describing the embodiments of the disclosure, a description of technical contents which are well known in the art to which the disclosure belongs and are not directly connected to the disclosure will be omitted. Unnecessary decryptions will be omitted in order to provide the gist of the disclosure more clearly without obscuring the same.

For the same reason, some components are exaggerated, omitted, or schematically illustrated in the accompanying drawings. Further, the size of each component does not exactly reflect the real size. In each drawing, the same or corresponding components are denoted by the same reference numerals.

Various advantages and features of the disclosure and methods accomplishing the same will become apparent from the following detailed description of embodiments with reference to the accompanying drawings. However, the disclosure is not limited to the embodiments disclosed herein but may be implemented in various forms. The embodiments have made the disclosure complete and are provided so that those skilled in the art can easily understand the scope of the disclosure. Therefore, the disclosure will be defined by the scope of the appended claims. Like reference numerals throughout the description denote like elements.

In this case, it may be understood that each block of processing flow charts and combinations of the flow charts may be performed by computer program instructions. Since these computer program instructions may be mounted in processors for a general computer, a special computer, or other programmable data processing apparatuses, these instructions executed by the processors for the computer or the other programmable data processing apparatuses generate a means for performing functions described in block(s) of the flow charts. Since these computer program instructions may also be stored in a computer usable or computer readable memory of a computer or other programmable data processing apparatuses in order to implement the functions in a specific scheme, the computer program instructions stored in the computer usable or computer readable memory may also produce manufacturing articles including an instruction means for performing the functions described in block(s) of the flow charts. Since the computer program instructions may also be mounted on the computer or the other programmable data processing apparatuses, the instructions for performing a series of operation steps on the computer or the other programmable data processing apparatuses to generate processes executed by the computer and to execute the computer or the other programmable data processing apparatuses may also provide steps for performing the functions described in block(s) of the flow charts.

In addition, each block may indicate some of modules, segments, or codes including one or more executable instructions for executing a specific logical function(s). Further, it is to be noted that functions mentioned in the blocks occur regardless of a sequence in some alternative embodiments. For example, two blocks that are consecutively illustrated may be simultaneously performed in fact or be performed in a reverse sequence depending on corresponding functions sometimes.

Here, the term “-unit” used in the embodiment means software or hardware components such as Field Programmable Gate Array (FPGA) and Application Specific Integrated Circuit (ASIC), and the “-unit” performs predetermined roles. However, the meag of the “-unit” is not limited to software or hardware. The “-unit” may be configured to be in a storage medium that may be addressed and may also be configured to reproduce one or more processor. Accordingly, for example, the “-unit” includes components such as software components, object-oriented software components, class components, task components and processors, functions, attributes, procedures, subroutines, segments of program code, drivers, firmware, microcode, circuits, data, a database, data structures, tables, arrays, and variables. The functions provided in the components and the “-units” may be combined as a smaller number of components and the “-units” or may be further separated into additional components and “-units”. In addition, the components and the “-units” may also be implemented to replicate one or more CPUs within a device or a security multimedia card. Further, in some embodiments, “-unit” may include one or more processors.

In the 5G system, a support for various services is considered compared to the existing 4G system. For example, the most representative services are an enhanced mobile broadband (eMBB) communication service, an ultra-reliable and low-latency communication (URLLC) service, a massive machine type communication (mMTC) service, an evolved multimedia broadcast/multicast service (eMBMS), etc. Further, a system providing the URLLC service may be referred to as an URLLC system, a system providing the eMBB service may be referred to as an eMBB system, and the like. In addition, the terms “service” and “system” may be interchangeably used with each other.

As described above, in a communication system, a plurality of services may be provided to a user. In order to provide a plurality of such services to a user, there is a need for a method capable of providing each service suitable for characteristics within the same time interval and an apparatus using the same.

In a wireless communication system, for example, in an LTE system, an LTE-advanced (LTE-A) system or a 5G new radio (NR) system, a base station and a terminal may be configured such that the base station transmits downlink control information (DCI) to the terminal, the DCI including resource assignment information for transmission of a downlink signal to be transmitted via a physical downlink control channel (PDCCH), and thus the terminal receives at least one downlink signal of the DCI (for example, a channel-state information reference signal (CSI-RS)), a physical broadcast channel (PBCH), or a physical downlink shared channel (PDSCH). For example, the base station transmits, in a subframe n, DCI indicating, to the terminal, reception of the PDSCH in the subframe n via the PDCCH, and upon reception of the DCI, the terminal receives the PDSCH in the subframe according to the received DCI. In addition, in the LTE, LTE-A, or NR system, the base station and the terminal may be configured such that the base station transmits DCI including uplink resource assignment information to the terminal via the PDCCH, and thus the terminal transmits at least one uplink signal of uplink control information (UCI) (for example, a sounding reference signal (SRS), UCI, or a physical random access channel (PRACH)) or a physical uplink shared channel (PUSCH) to the base station. For example, the terminal having received, from the base station via the PDCCH, uplink transmission configuration information (or uplink DCI or UL grant) in a subframe n may perform uplink data channel transmission (hereinafter, referred to as “PUSCH transmission”) according to a pre-defined time (for example, n+4), a time configured via a higher-layer signal (for example, n+k), or uplink signal transmission time indicator information included in the uplink transmission configuration information.

In a case where configured downlink transmission is transmitted from the base station to the terminal via an unlicensed band, or configured uplink transmission is transmitted from the terminal to the base station via the unlicensed band, a transmission device (the base station or the terminal) may perform a channel access procedure or listen-before talk (LBT) procedure on the unlicensed band where a signal transmission is configured before or immediately before a start of the configured signal transmission. According to a result of performing the channel access procedure, when it is determined that the unlicensed band is in an idle state, the transmission device may access the unlicensed band and then perform the configured signal transmission. According to the result of the channel access procedure performed by the transmission device, when it is determined that the unlicensed band is not in the idle state or that the unlicensed band is in an occupied state, the transmission device fails to access the unlicensed band and thus fails to perform the configured signal transmission. In general, in the channel access procedure via the unlicensed band where signal transmission is configured, the transmission device may determine the idle state of the unlicensed band by receiving a signal via the unlicensed band during a predetermined time or a time calculated according to a pre-defined rule (for example, a time calculated using a random value selected by the base station or the terminal), and comparing a strength of the received signal and a threshold value that is pre-defined or calculated by using a function of at least one parameter including a channel bandwidth, a bandwidth of a signal to be transmitted, the intensity of transmission power, or a beamwidth of a transmission signal. For example, when a strength of a signal received by the transmission device for 25 μs is less than −72 dBm, that is, a pre-defined threshold, the transmission device may determine that the unlicensed band is in the idle state and thus may perform the configured signal transmission. In this case, a maximum available time of the signal transmission may be limited according to a maximum channel occupancy time in the unlicensed band, which is defined according to each country or each region, or a type (for example, the base station, the terminal, a master device or a slave device) of the transmitting apparatus. For example, in Japan, the base station or the terminal in 5 GHz of the unlicensed band may perform the channel access procedure and then may transmit, during a maximum of 4 ms, a signal by occupying a channel without additionally performing the channel access procedure. When the strength of the signal received by for 25 μs is greater than −72 dBm, which is the predefined threshold, the base station may determine that the unlicensed band is not in the idle state and transmits no signal.

In the 5G communication system, in order to provide various services and support a high data transmission rate, various technologies such as a technology capable of performing re-transmission in units of code block groups and transmitting an uplink signal without UL scheduling information have been introduced. Accordingly, to perform 5G communication via the unlicensed band, a more efficient channel access procedure based on various parameters is required.

Wireless communication systems have expanded beyond the original role of providing a voice-oriented service and have evolved into wideband wireless communication systems that provide a high-speed and high-quality packet data service according to, for example, communication standards such as high-speed packet access (HSPA), long-term evolution (LTE or evolved universal terrestrial radio access (E-UTRA)), and LTE-Advanced (LTE-A) of 3GPP, high-rate packet data (HRPD) and a ultra-mobile broadband (UMB) of 3GPP2, and 802.16e of IEEE. In addition, 5G or NR communication standards are being established for a 5G wireless communication system.

In a wireless communication system including the 5G system, at least one of services including eMBB, mMTC, and URLLC may be provided to the terminal. The services may be provided to a same terminal during a same time interval. In an embodiment, the eMBB may be a service aiming at high-speed transmission of large-capacity data, the mMTC may be a service aiming at minimizing terminal power and connecting multiple terminals, and the URLLC may be a service aiming at high reliability and low latency, but the disclosure is not limited thereto. The above three services may be major scenarios in a system such as an LTE system or a 5G or new-radio/next-radio (NR) system beyond LTE.

In a case where a base station has scheduled data corresponding to an eMBB service for a terminal in a particular transmission time interval (TTI), when the situation in which URLLC data is to be transmitted in the TTI occurs, the base station does not transmit some of eMBB data in a frequency band in which the eMBB data has already been scheduled and transmitted, but may transmit the generated URLLC data in the frequency band. A terminal for which the eMBB has been scheduled and a terminal for which URLLC has been scheduled may be the same terminal or different terminals. In such a case, the possibility that the eMBB data may be damaged increases because there is a portion in which some of the already scheduled and transmitted eMBB data are not transmitted. Accordingly, in the above case, there is a need for a method of processing a signal received by the terminal for which eMBB has been scheduled or the terminal for which URLLC has been scheduled and a method of receiving a signal.

Hereinafter, the disclosure is described in detail with reference to the accompanying drawings. When it is determined that a detailed description for the function or configuration related to the disclosure may obscure the gist of the disclosure, the detailed description therefor will be omitted. Further, in the description of the disclosure, the following terminologies are defined in consideration of the functions in the disclosure and may be construed in different ways by the intention or practice of users and operators. Therefore, the definitions thereof should be construed based on the contents throughout the specification. Hereinafter, a base station is an entity that assigns resources of a terminal, and may be at least one of an eNode B, a Node B, a BS, a wireless access unit, a BS controller, or a node on a network. A terminal may include a user equipment (UE), a mobile station (MS), a cellular phone, a smartphone, a computer, or a multimedia system capable of performing a communication function. In the disclosure, a downlink (DL) means a radio transmission path of a signal transmitted from a base station to a terminal, and an uplink (UL) means a radio transmission path of a signal transmitted from a terminal to a base station. Furthermore, hereinafter, the LTE or LTE-A system is described as an example in the disclosure, but is not limited thereto, and embodiments of the disclosure may be applied to other communication systems having a similar technical background or channel type, and a 5th-generation mobile communication technology (5G or new-radio (NR)) developed beyond LTE-A can be included therein, for example. Furthermore, an embodiment of the disclosure may be applied to other communication systems through some modifications without greatly departing from the range of the disclosure based on a determination of those having skilled technical knowledge.

As a representative example of the broadband wireless communication systems, in an NR system, an orthogonal frequency-division multiplexing (OFDM) scheme has been adopted for a downlink (DL), and both the OFDM scheme and a single carrier frequency division multiple access (SC-FDMA) scheme have been adopted for an uplink (UL). The uplink indicates a radio link through which data or a control signal is transmitted from a terminal (a user equipment (UE) or a mobile station (MS)) to a base station (an eNode B or a BS), and the downlink indicates a radio link through which data or a control signal is transmitted from a base station to a terminal. In the above-mentioned multiple-access scheme, normally, data or control information is distinguished according to a user by assigning or managing time-frequency resources for carrying data or control information of each user, wherein the time-frequency resources do not overlap, that is, orthogonality is established.

In a 5G system, flexibly defining and operating a frame structure may be required in consideration of various services and requirements. For example, services may have different subcarrier spacings according to the requirements. In a current 5G communication system, a scheme of supporting a plurality of subcarrier spacings may be determined by using [Equation 1] below.

Δf=f₀2^{m} [Equation 1]

Here, f₀ indicates a default subcarrier spacing in a system, and m indicates a scaling factor that is an integer. For example, when f-₀ is 15 kHz, a set of subcarrier spacings that the 5G communication system can have may include 3.75 kHz, 7.5 kHz, 15 kHz, 30 kHz, 60 kHz, 120 kHz, 240 kHz, 480 kHz, or the like. An available set of subcarrier spacings may vary according to a frequency band. For example, in a frequency band equal to or less than 6 GHz, 3.75 kHz, 7.5 kHz, 15 kHz, 30 kHz, and 60 kHz may be used, and in a frequency band equal to or greater than 6 GHz, 60 kHz, 120 kHz, and 240 kHz may be used.

The length of an OFDM symbol may vary depending on the subcarrier spacing constituting the OFDM symbol. This is because the subcarrier spacing and the OFDM symbol length are inversely proportional to each other, which is a characteristic feature of OFDM symbols. For example, when the subcarrier spacing doubles, the symbol length becomes half, and when the subcarrier spacing becomes half, the symbol length doubles.

The NR system adopts a hybrid automatic repeat request (HARQ) scheme such that, when decoding fails during the initial transmission, the corresponding data is re-transmitted in the physical layer. According to the HARQ scheme, when a receiver fails to accurately decode data, the receiver transmits information indicating the decoding failure (negative acknowledgement (NACK)) to a transmitter such that the transmitter can retransmit the corresponding data in the physical layer. The receiver combines data retransmitted by the transmitter with data, which has previously failed to be decoded, thereby increasing the data receiving performance. In addition, when the receiver accurately decodes data, the receiver transmits information indicating the successful decoding (acknowledgement (ACK)) to the transmitter such that the transmitter can transmit new data.

FIG. 1 illustrates a basic structure of a time-frequency domain, which is a radio resource area in which a data or control channel is transmitted in up/downlink in an NR system or a system similar thereto according to an embodiment of the disclosure.

Referring to FIG. 1, a horizontal axis indicates a time domain, and a vertical axis indicates a frequency domain. A minimum transmission unit in the time domain is an OFDM symbol or DFT-s-OFDM symbol, and N_{symb} OFDM symbols 101 gather to configure one slot 102. Here, the OFDM symbol represents a symbol used to transmit or receive a signal by using an OFDM multiplexing scheme, and the DFT-s-OFDM symbol represents a symbol used to transmit or receive a signal by using a DFT-s-OFDM multiplexing scheme or an SC-FDMA multiplexing scheme. Hereinafter, for convenience of description, the OFDM symbol and the DFT-s-OFDM symbol are not distinguished from each other and thus are collectively referred to as an OFDM symbol, and will now be described with reference to reception or transmission of a downlink signal, but may also be applied to reception or transmission of an uplink signal.

When spacing between subcarriers is 15 kHz, one slot constitutes one subframe 103 and lengths of the slot and the subframe may each be 1 ms. The number of the slots constituting one subframe 103, and a length of the slot may vary according to spacing between subcarriers. For example, when spacing between subcarriers is 30 kHz, four slots gather to constitute one subframe 103. In this case, a length of the slot is 0.5 ms, and a length of the subframe is 1 ms. A radio frame 104 may be a time domain period composed of 10 subframes. A minimum transmission unit in the frequency domain is a subcarrier, and a transmission bandwidth of a whole system is composed of N_{BW} subcarriers 105. However, these specific numerical values may be variably applied. For example, in the LTE system, spacing between subcarriers is 15 kHz, two slots gather to constitute one subframe 103, and in this case, a length of the slot is 0.5 ms and a length of the subframe is 1 ms.

A basic unit of a resource in the time-frequency domain is a resource element (RE) 106 and may be expressed as a symbol index and a subcarrier index. A resource block (RB or a physical resource block (PRB)) 107 may be defined as N_{symb} consecutive OFDM symbols 101 in the time domain and N_{SC}^{RB} consecutive subcarriers 108 in the frequency domain. Therefore, one RB 107 in one slot may include N_{symb} X N_{SC}^{RB} number of REs. In general, a minimum data assignment unit in the frequency domain is the RB 107. In the NR system, N_{symb}=14 and N_{SC}^{RB}=12, and the number of RBs (N RB) may change according to a bandwidth of a system transmission band. In the LTE system, generally, N_{symb}=7 and N_{SC}^{RB}=12, and N_{RB} may change according to a bandwidth of a system transmission band.

Downlink control information may be transmitted within first N OFDM symbols in the subframe. Generally, N={1, 2, 3}, and the number of symbols in which the downlink control information is transmittable via a higher-layer signal may be configured for the terminal by the base station. In addition, according to the amount of control information to be transmitted in a current slot, the base station may change, for each slot, the number of symbols in which downlink control information is transmittable in a slot, and may transfer information on the number of symbols to the terminal via a separate downlink control channel.

In the NR system, one component carrier (CC) or serving cell may include up to 250 RBs. Therefore, when a terminal always receives the entire serving cell bandwidth as in the LTE system, the power consumption of the terminal may be extreme. To solve this problem, a base station may configure one or more bandwidth parts (BWP) for the terminal, thus supporting the terminal in changing a reception area in the cell. In the NR system, the base station may configure an “initial BWP”, which is the bandwidth of CORESET #0 (or a common search space (CSS)), for the terminal through a master information block (MIB). Subsequently, the base station may configure the initial BWP (the first BWP) for the terminal through radio resource control (RRC) signaling, and may report at least one piece of BWP configuration information that may be indicated through downlink control information (DCI) later. The base station may report a BWP ID through DCI, thereby indicating a band to be used by the terminal. When the terminal fails to receive the DCI in the currently allocated BWP for a specified time or longer, the terminal returns to a “default BWP” and attempts to receive the DCI.

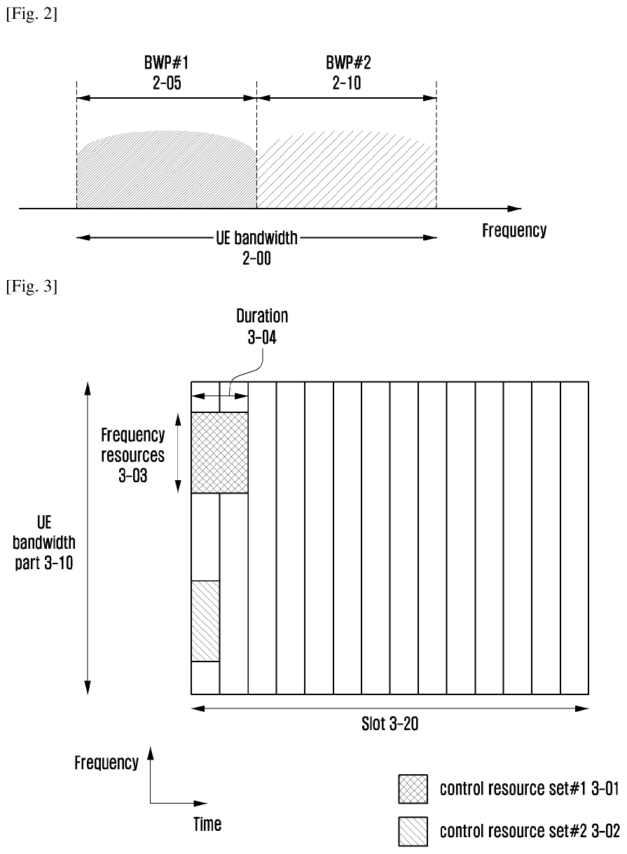

FIG. 2 illustrates an example of the configuration of a bandwidth part (BWP) in a wireless communication system according to an embodiment of the disclosure.

Referring to FIG. 2, FIG. 2 shows an example in which a terminal bandwidth 2-00 is configured with two bandwidth parts, that is, BWP #1 2-05 and BWP #2 2-10. A base station may configure one bandwidth part or a plurality of bandwidth parts for the terminal, and may configure, for each bandwidth part, information as shown in [Table 1].

TABLE 1

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(the location of the bandwidth part)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |
| (cyclic prefix) | |
| } | |

The disclosure is not limited to the above-described example, and not only the configuration information but also various parameters related to the bandwidth part may be configured for the terminal. The information may be transferred from the base station to the terminal through higher-layer signaling, for example, radio resource control (RRC) signaling. Among one or multiple configured bandwidth parts, at least one bandwidth part may be activated. Information indicating whether to activate the configured bandwidth part may be semi-statically transferred from the base station to the terminal through RRC signaling, or may be dynamically transferred through a MAC control element (CE) or DCI.

According to an embodiment, the terminal before the RRC connection may receive the configuration of an initial bandwidth part (initial BWP) for initial access from the base station through a master information block (MIB). More specifically, the terminal may receive configuration information relating to a control resource set (CORESET) and a search space in which a PDCCH can be transmitted in order to receive system information (remaining system information (RMSI) or system information block 1 (SIB1)) required for initial access through the MIB in an initial access step. Each of the control resource set and the search space configured through the MIB may be considered as identity (ID) 0.

The base station may inform the terminal of configuration information such as frequency allocation information, time allocation information, and numerology for control resource set #0 through the MIB. Further, the base station may inform the terminal of configuration information relating to a monitoring period and occasion of control resource set #0, that is, configuration information relating to search space #0, through the MIB. The terminal may consider a frequency region configured as control resource set #0 acquired from the MIB as an initial bandwidth part for initial access. In this case, the ID of the initial bandwidth part may be considered as 0.

In relation to a method for configuring the bandwidth part, terminals before RRC-connected may receive configuration information of an initial bandwidth part through a master information block (MIB). More specifically, a control resource set (CORESET) for a downlink control channel through which downlink control information (DCI) for scheduling a system information block (SIB) can be transmitted may be configured for the terminal through an MIB of a physical broadcast channel (PBCH). The bandwidth of the control resource set configured by the MIB may be considered as an initial bandwidth part, and the terminal may receive a PDSCH through which the SIB is transmitted, through the configured initial bandwidth part. An initial bandwidth part may be used for other system information (OSI), paging, and random access in addition to the reception of the SIB.

In the following description, a synchronization signal (SS)/PBCH block in a next-generation mobile communication system (a 5G system or NR system) will be described.

An SS/PBCH block means a physical layer channel block including a primary SS (PSS), a secondary SS (SSS), and a PBCH. More specifically, the SS/PBCH block is defined below.
PSS: This indicates a signal serving as a reference for downlink time/frequency synchronization and provides a part of information of a cell ID.
SSS: This is a reference for downlink time/frequency synchronization and provides the remaining cell ID information which a PSS does not provide. Additionally, the SSS may serve as a reference signal for demodulating a PBCH.
PBCH: This provides necessary system information required for transmitting or receiving a data channel and a control channel by a terminal. The necessary system information may include search space-related control information indicating wireless resource mapping information of a control channel, and scheduling control information of a separate data channel for transmitting system information.
SS/PBCH block: An SS/PBCH block includes a combination of a PSS, an SSS, and a PBCH. One SS/PBCH block or a plurality of SS/PBCH blocks may be transmitted within 5 ms, and each of transmitted SS/PBCH blocks may be distinguished from each other by an index.

The terminal may detect the PSS and the SSS and decode the PBCH in the initial access stage. An MIB may be obtained from the PBCH and control resource set #0 may be configured from the MIB. The terminal may monitor control resource set #0 under the assumption that a selected SS/PBCH block and a demodulation reference signal (DMRS) transmitted on control resource set #0 are in a quasi-co-location (QCL). The terminal may receive system information from downlink control information transmitted on control resource set #0. The terminal may obtain, from the received system information, configuration information related to a random access channel (RACH) required for initial access. The terminal may transmit a physical RACH (PRACH) to the base station in consideration of a selected SS/PBCH index, and the base station having received the PRACH may obtain information on the SS/PBCH block index selected by the terminal. The base station may monitor a block which the terminal selects from among SS/PBCH blocks, and control resource set #0 corresponding to (or associated with) the selected SS/PBCH block.

In the following description, downlink control information (hereinafter, referred to as “DCI”) in a next-generation mobile communication system (a 5G system or an NR system) will be described in detail.

In the next-generation mobile communication system (the 5G system or the NR system), scheduling information on uplink data (or a physical uplink data channel (a physical uplink shared channel (PUSCH))) or downlink data (or a physical downlink data channel (a physical downlink shared channel, (PDSCH))) can be transferred through DCI from a base station to a terminal. The terminal may monitor a fallback DCI format and a non-fallback DCI format for a PUSCH or a PDSCH. The fallback DCI format may include a fixed field pre-defined between the base station and the terminal, and the non-fallback DCI format may include a configurable field.

The DCI may be subjected to a channel coding and modulation procedure, and then transmitted through a physical downlink control channel (PDCCH). A cyclic redundancy check (CRC) may be attached to a DCI message payload, and the CRC may be scrambled by a radio network temporary identifier (RNTI) corresponding to the identity of the terminal. Different types of RNTIs can be used for scrambling the CRC, which is attached to the DCI message payload, according to the purpose of a DCI message, for example, UE-specific data transmission, a power control command, a random access response, or the like. That is, an RNTI is not explicitly transmitted, and may be included in a CRC calculation procedure so as to be transmitted. When a DCI message transmitted on a PDCCH is received, the terminal may identify a CRC by using an allocated RNTI. When a CRC identification result indicates matching of the RNTI, the terminal may identify that the message has been transmitted to the terminal.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying a slot format indicator (SFI) may be scrambled by an SFI-RNTI. DCI for notifying a transmission power control (TPC) may be scrambled by a TPC-RNTI. DCI for scheduling a UE-specific PDSCH or PUSCH may be scrambled by a cell RNTI (C-RNTI).

DCI format 0_0 may be used for fallback DCI for scheduling a PUSCH, and in this case, a CRC may be scrambled by a C-RNTI. In an embodiment, DCI format 0_0 having a CRC scrambled by a C-RNTI may include the following information as shown in [Table 2].

TABLE 2

| | |
|---|---|
| - | Identifier for DCI formats (DCI format identifier) - [1] bit |
| - | Frequency domain resource assignment - |
| | [┌log₂( N_{RB}^{UL,BWP}(N_{RB}^{UL,BWP} + 1)/2┐] bits |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | TPC command for scheduled PUSCH - [2] bits |
| - | Uplink/supplementary uplink (UL/SUL) indicator - 0 or 1 bit |

DCI format 0_1 may be used for non-fallback DCI for scheduling a PUSCH, and in this case, a CRC may be scrambled by a C-RNTI. In an embodiment, DCI format 0_1 having a CRC scrambled by a C-RNTI may include the following information as shown in [Table 3].

TABLE 3

| - | Carrier indicator - 0 or 3 bits | |
|---|---|---|
| - | UL/SUL indicator - 0 or 1 bit | |
| - | Identifier for DCI formats - [1] bits | |
| - | Bandwidth part indicator - 0, 1, or 2 bits | |
| - | Frequency domain resource assignment | |
| | • | For resource allocation type 0, ┌N_{RB}^{UL,BWP} /P┐bits |
| | • | For resource allocation type 1, ┌log₂( N_{RB}^{UL,BWP} (N_{RB}^{UL,BWP} + |
| | | 1)/2)┐ bits |

| | |
|---|---|
| - | Time domain resource assignment -1, 2, 3, or 4 bits |
| - | VRB-to-PRB mapping (mapping between virtual resource |
| | block and physical resource block) - |

0 or 1 bit, only for resource allocation type 1.

| | • | 0 bit if only resource allocation type 0 is configured; |
|---|---|---|
| | • | 1 bit otherwise. |
| - | Frequency hopping flag - 0 or 1 bit, only for resource | |
| | allocation type 1. | |
| | • | 0 bit if only resource allocation type 0 is configured; |
| | • | 1 bit otherwise. |
| - | Modulation and coding scheme - 5 bits | |
| - | New data indicator - 1 bit | |
| - | Redundancy version - 2 bits | |
| - | HARQ process number - 4 bits | |
| - | 1st downlink assignment index - 1 or 2 bits | |
| | • | 1 bit for semi-static HARQ-ACK codebook; |
| | • | 2 bits for dynamic HARQ-ACK codebook with single |
| | | HARQ-ACK codebook. |
| - | 2nd downlink assignment index - 0 or 2 bits | |
| | • | 2 bits for dynamic HARQ-ACK codebook with two |
| | | HARQ-ACK sub-codebooks; |
| | • | 0 bit otherwise. |
| - | TPC command for scheduled PUSCH - 2 bits | |
| - | SRS resource indicator - ┌log₂(Σₖ₌₁^{L}^{ₘₐₓ}(ₖ^{N}^{_{SRS}}))┐ or ┌log₂(N_{SRS})┐ bits | |
| | • | ┌log₂(Σₖ₌₁^{L}^{ₘₐₓ}(ₖ^{N}^{_{SRS}}))┐ bits for non-codebook based PUSCH |
| | | transmission(if PUSCH transmission is not based on codebook); |
| | • | ┌log₂(N_{SRS})┐ bits for codebook based PUSCH transmission(if |
| | | PUSCH transmission is based on codebook). |

| | |
|---|---|
| - | Precoding information and number of layers - up to 6 bits |
| - | Antenna ports - up to 5 bits |
| - | SRS request - 2 bits |
| - | CSI request (wherein CSI indicates channel state information) - |
| | 0, 1, 2, 3, 4, 5, or 6 bits |
| - | Code block group (CBG) transmission information - 0, 2, 4, 6, or 8 bits |
| - | Phase tracking reference signal (PTRS)-Demodulation reference |
| | signal (DMRS) association - 0 |

or 2 bits.

| | |
|---|---|
| - | beta_offset indicator - 0 or 2 bits |
| - | DMRS sequence initialization - 0 or 1 bit |

DCI format 1_0 may be used for fallback DCI for scheduling a PDSCH, and in this case, a CRC may be scrambled by a C-RNTI. In an embodiment, DCI format 1_0 having a CRC scrambled by a C-RNTI may include the following information as shown in [Table 4].

TABLE 4

| | |
|---|---|
| - | Identifier for DCI formats - [1] bit |
| - | Frequency domain resource assignment - |
| | [┌log₂( N_{RB}^{DL,BWP}(N_{RB}^{DL,BWP} + 1)/2)┐] bits |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Physical uplink control channel (PUCCH) resource indicator - |
| | 3 bits |
| - | PDSCH-to-HARQ feedback timing indicator - [3] bits |

Alternatively, DCI format 1_0 may be used for DCI for scheduling a PDSCH relating to an RAR message, and in this case, a CRC may be scrambled by an RA-RNTI. In an embodiment, DCI format 1_0 having a CRC scrambled by an RA-RNTI may include the following information as shown in [Table 5].

TABLE 5

| | |
|---|---|
| - | Frequency domain resource assignment - |
| | [┌log₂( N_{RB}^{DL,BWP}(N_{RB}^{DL,BWP} + 1)/2)┐] bits |
| - | Time domain resource assignment - 4 bits |
| - | VRB-to-PRB mapping - 1 bit |
| - | Modulation and coding scheme - 5 bits |
| - | TB scaling - 2 bits |
| - | Reserved bits - 16 bits |

DCI format 1_1 may be used for non-fallback DCI for scheduling a PDSCH, and in this case, a CRC may be scrambled by a C-RNTI. In an embodiment, DCI format 1_1 having a CRC scrambled by a C-RNTI may include information as shown in [Table 6].

TABLE 6

| - | Carrier indicator - 0 or 3 bits | |
|---|---|---|
| - | Identifier for DCI formats - [1] bits | |
| - | Bandwidth part indicator - 0, 1, or 2 bits | |
| - | Frequency domain resource assignment | |
| | • | For resource allocation type 0, ┌N_{RB}^{DL,BWP} /P┐bits |
| | • | For resource allocation type 1, ┌log₂( N_{RB}^{DL,BWP}(N_{RB}^{DL,BWP} + |
| | | 1)/2)┐ bits |
| - | Time domain resource assignment -1, 2, 3, or 4 bits | |
| - | VRB-to-PRB mapping - 0 or 1 bit, only for resource allocation | |
| | type 1. | |
| | • | 0 bit if only resource allocation type 0 is configured; |
| | • | 1 bit otherwise. |

| | |
|---|---|
| - | Physical resource block (PRB) bundling size indicator - 0 or 1 bit |
| - | Rate matching indicator - 0, 1, or 2 bits |
| - | Zero power channel state information-reference signal (ZP |
| | CSI-RS) trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5, or 6 bits |
| - | Transmission configuration indication - 0 or 3 bits |
| - | SRS request - 2 bits |
| - | Code block group (CBG) transmission information - 0, 2, 4, 6, |
| | or 8 bits |
| - | CBG flushing out information - 0 or 1 bit |
| - | DMRS sequence initialization - 1 bit |

FIG. 3 illustrates an embodiment of a control resource set (CORESET), on which a downlink control channel is transmitted, in a 5G wireless communication system according to an embodiment of the disclosure.

Referring to FIG. 3, FIG. 3 shows an embodiment in which a terminal (UE) bandwidth part 3-10 is configured along a frequency axis, and two control resource sets (control resource set #1 3-01 and control resource set #2 3-02) are configured in one slot 3-20 along a time axis. The control resource sets 3-01 and 3-02 may be configured in a particular frequency resource 3-03 in the terminal bandwidth part 3-10 along the frequency axis. In the control resource sets 3-01 and 3-02, one OFDM symbol or multiple OFDM symbols may be configured along the time axis, and the configured OFDM symbol or symbols may be defined as a control resource set duration 3-04. Referring to FIG. 3, control resource set #1 3-01 may be configured to have a control resource set duration of two symbols, and control resource set #2 3-02 may be configured to have a control resource set duration of one symbol.

A control resource set in the above-described next-generation mobile communication system (the 5G system or the NR system) may be configured for a terminal by a base station via higher-layer signaling (for example, system information, master information block (MIB), and radio resource control (RRC) signaling). Configuring a control resource set for a terminal means providing information such as a control resource set identifier (identity), the frequency location of the control resource set, the symbol length of the control resource set, etc. For example, the configuration of the control resource set may include the following information as shown in [Table 7].

TABLE 7

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identifier(Identity))

| | |
|---|---|
| frequencyDomainResources | BIT STRING (SIZE (45)), |

(frequency-axis resource assignment information)

| | |
|---|---|
| duration | INTEGER (1..maxCoReSetDuration), |

(time-axis resource assignment information)

| | |
|---|---|
| cce-REG-MappingType | CHOICE { |

(CCE-to-REG mapping scheme)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG-bundle, |

allContiguousRBs},

| | |
|---|---|
| interleaverSize | ENUMERATED {n2, n3, n6} |

(interleaver size)

| | |
|---|---|
| shiftIndex | INTEGER(0..maxNrofPhysicalResourceBlocks−1) |

```
    (interleaver shift)
  },
```

| | |
|---|---|
| nonInterleaved | NULL |

},

| | |
|---|---|
| tci-StatesPDCCH | SEQUENCE(SIZE (1..maxNrofTCI-StatesPDCCH)) |
| OF TCI-StateId | OPTIONAL, |

(QCL configuration information)

| | |
|---|---|
| tci-PresentInDCI | ENUMERATED {enabled} |

}

The tci-StatesPDCCH (hereinafter, referred to as a “TCI state”) configuration information shown in [Table 7] may include information on the index or indices of one synchronization signal (SS)/physical broadcast channel (PBCH) block or multiple SS/PBCH blocks which are in a quasi-co-located (QCL) relationship with a demodulation reference signal (DMRS) transmitted on a corresponding control resource set, or information on the index of a channel state information reference signal (CSI-RS). The frequencyDomainResources configuration information configures a frequency resource of the corresponding CORESET as a bitmap, wherein each bit indicates a group of non-overlapping six PRBs. The first group means a group of six PRBs having the first PRB index of 6·┌N_{BWP}^{start}/6┐, wherein N_{BWP}^{start} indicates a start point of a BWP. The most significant bit of the bitmap indicates the first group and the bits are configured in an ascending order.

In the wireless communication system, different antenna ports (which can be replaced with one or more channels, signals, or a combination thereof, but is collectively referred to as “different antenna ports” for convenience of further description in the disclosure) may be associated with each other according to QCL configuration as shown in [Table 8] below.

TABLE 8

| | |
|---|---|
| QCL-Info ::= | SEQUENCE |
| cell | ServCellIndex (an index of a serving |

cell in which QCL reference RS is transmitted)

| | |
|---|---|
| bwp-ID | BWP-Id (an index of a bandwidth part |

in which QCL reference RS is transmitted)

| | |
|---|---|
| referenceSignal | CHOICE { (an indicator indicating one of CSI- |

RS and SS/PBCH as a QCL reference RS)

| | |
|---|---|
| csi-rs | NZP-CSI-RS-ResourceId, |
| ssb | SSB-Index |

},

| | |
|---|---|
| qcl-Type | ENUMERATED {typeA, typeB, |

typeC, type D}, (QCL type indicator)
...
}

Specifically, in QCL configuration, two different antenna ports can be associated with each other based on relationships between a (QCL) target antenna port and a (QCL) reference antenna port. The terminal may apply (or assume) all or some of channel statistical characteristics measured by the reference antenna port (for example, a large-scale parameter of a channel, such as a Doppler shift, a Doppler spread, an average delay, a delay spread, an average gain, a spatial Rx (or Tx) parameter, a reception space filter parameter of the terminal, or a transmission space filter parameter of the terminal) at the time of target antenna port reception. In the description above, the target antenna means an antenna port for transmitting a channel or a signal configured by higher-layer configuration including the QCL configuration, or an antenna port for transmitting a channel or a signal for transmitting a channel or a signal to which a TCI state indicating the QCL configuration is applied. The reference antenna port means an antenna port for transmitting a channel or a signal indicated (or specified) by a referenceSignal parameter in the QCL configuration.

Specially, channel statistical characteristics specified by the QCL configuration (or indicated by the parameter qcl-Type in the QCL configuration) may be classified as below according to a QCL type.

* ‘QCL-TypeA’: {Doppler shift, Doppler spread, average delay, delay spread}

* ‘QCL-TypeB’: {Doppler shift, Doppler spread}

* ‘QCL-TypeC’: {Doppler shift, average delay}

* ‘QCL-TypeD’: {Spatial Rx parameter}

In this case, the QCL type is not limited to the four types above, but all possible combinations are not enumerated in order not to obscure the gist of the description. QCL-TypeA corresponds to a QCL type used in a case where the bandwidth and the transport interval of the target antenna port are more sufficient than those of the reference antenna port (that is, in a case where the number of samples and the transmission bandwidth/time of the target antenna port are greater than the number of samples and the transmission bandwidth/time of the reference antenna port in both the frequency axis and the time axis), and thus all statistical characteristics measurable in the frequency axis and the time axis can be referred to. QCL-TypeB corresponds to a QCL type used in a case where the bandwidth of the target antenna port is sufficient to measure statistical characteristics, that is, the Doppler shift and Doppler spread parameters, measurable in the frequency. QCL-TypeC corresponds to a QCL type used in a case where the bandwidth and the transport interval of the target antenna port are insufficient to measure second-order statistics, that is, the Doppler spread and delay spread parameters, and thus only first-order statistics, that is, only the Doppler shift and average delay parameters, can be referred to. QCL-TypeD corresponds to a QCL type configured when spatial reception filter values used at the time of reference antenna port reception can be used at the time of target antenna port reception.

The base station may configure or indicate the maximum two QCL configurations for or to the target antenna port through TCI state configuration as shown in [Table 9a] below.

TABLE 9a

| | |
|---|---|
| TCI-State ::= | SEQUENCE { |
| tci-StateId | TCI-StateId, (TCI state indicator) |
| qcl-Type1 | QCL-Info, (the first QCL configuration for the target |

antenna port to which the corresponding TCI state is applied)

| | |
|---|---|
| qcl-Type2 | QCL-Info (the second QCL configuration for the target |

antenna port to which the corresponding TCI state is applied)

OPTIONAL, -- Need R

...
}

The first QCL configuration among two QCL configurations included in one TCI state configuration may be configured to be one of QCL-TypeA, QCL-TypeB, and QCL-TypeC. In this case, the configurable QCL type is specified by the types of the target antenna port and the reference antenna port and will be described in detail below. In addition, the second QCL configuration among two QCL configurations included in the TCI state configuration may be configured to be QCL-TypeD and can be omitted in some cases.

Tables 9ba to 9be show valid TCI state configurations according to the type of the target antenna port.

Table 9ba shows valid TCI state configurations in a case where the target antenna port is a CSI-RS for tracking (TRS). The TRS means an NZP CSI-RS, for which no repetition parameter is configured and trs-Info is configured to have a value of “true”, among CSI-RSs. In Table 9ba, when configuration 3 is configured, the target antenna port can be used for an aperiodic TRS.

TABLE 9ba
Valid TCI state configurations when target
antenna port is CSI-RS for tracking (TRS)

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 9bb shows valid TCI state configurations in a case where the target antenna port is a CSI-RS for CSI. The CSI-RS means an NZP CSI-RS, for which neither repetition parameter is configured nor trs-Info is configured to have a value of “true”, among CSI-RSs.

TABLE 9bb
Valid TCI state configurations when
target antenna port is CSI-RS for CSI

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 9bc shows valid TCI state configurations in a case where the target antenna port is a CSI-RS for beam management (BM) (that is identical to a CSI-RS for L1 RSRP reporting). The CSI-RS of BM means an NZP CSI-RS for which a repetition parameter is configured and has a value of “on” or “off” and no trs-info is configured to have a value of “true”, among CSI-RSs.

TABLE 9bc
Valid TCI state configurations when target antenna
port is CSI-RS for BM (for L1 RSRP reporting)

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 9bd shows valid TCI state configurations when the target antenna port is a PDCCH DMRS.

TABLE 9bd
Valid TCI state configurations when
target antenna port is PDCCH DMRS

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 9be shows valid TCI state configurations when the target antenna port is a PDSCH DMRS.

TABLE 9be
Valid TCI state configurations when
target antenna port is PDSCH DMRS

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

In the representative QCL configuration scheme according to Tables 9ba to 9be, the target antenna port and the reference antenna port at each stage are configured and managed such as “SSB”→“TRS”→“CSI-RS for CSI, CSI-RS for BM, PDCCH DMRS, or PDSCH DMRS”. Accordingly, the statistical characteristics measurable from the SSB and the TRS are associated with the antenna ports, and thus a reception operation by the terminal can be assisted.

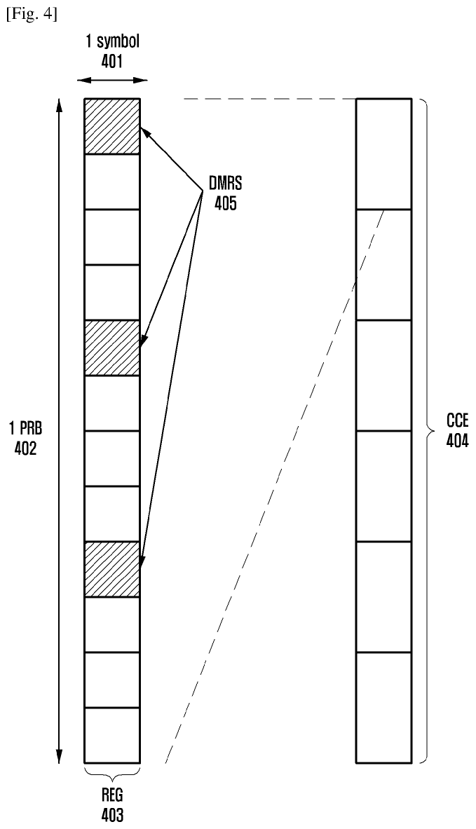

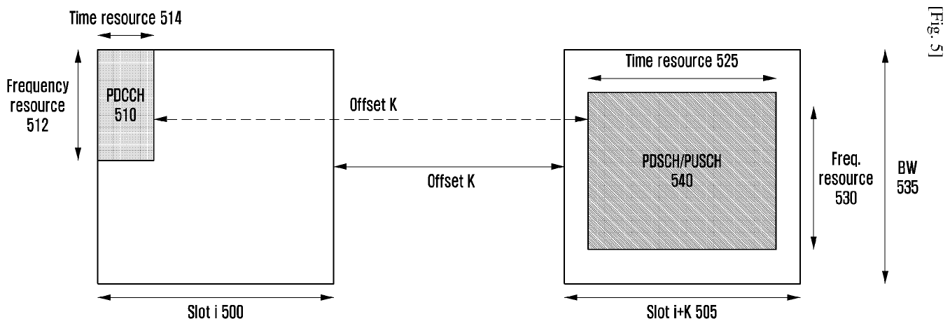

FIG. 4 illustrates a structure of a downlink control channel in a wireless communication system according to an embodiment of the disclosure. That is, FIG. 4 illustrates an example of a basic unit of a time and a frequency resource included in a downlink control channel which can be used by 5G according to an embodiment of the disclosure.

Referring to FIG. 4, the basic unit of a time and a frequency resource included in the control channel may be defined by a resource element group (REG) 403. The REG 403 may be defined as one OFDM symbol 401 on the time axis and one physical resource block (PRB) 402 on the frequency axis, that is, as 12 subcarriers. It is possible to configure a downlink control channel allocation unit by concatenating the REG 403.

As illustrated in FIG. 4, when the basic unit in which the downlink control channel is allocated in the 5G system is a control channel element (CCE) 404, one CCE 404 may include a plurality of REGs 403. For example, the REG 403 in FIG. 4 may include 12 REs, and when one CCE 404 includes six REGs 403, one CCE 404 may include 72 REs. When a downlink control resource set is configured, the corresponding resource set may include a plurality of CCEs 404, and a particular downlink control channel may be mapped to one or a plurality of CCEs 404 according to an aggregation level (AL) within the control resource set and may then be transmitted. The CCEs 404 within the control resource set may be distinguished by numbers, and the numbers of the CCEs 404 may be assigned according to a logical mapping scheme.

The basic unit of the downlink control channel illustrated in FIG. 4, that is, the REG 403, may include all REs to which the DCI is mapped and the region to which a DMRS 405, which is a reference signal for decoding the REs, is mapped. As illustrated in FIG. 4, three DMRSs 405 may be transmitted within one REG 403. The number of CCEs required to transmit the PDCCH may be 1, 2, 4, 8, or 16 according to the aggregation level (AL), and the different number of CCEs may be used to implement link adaptation of the downlink control channel. For example, when AL=L, one downlink control channel may be transmitted through L CCEs.

The terminal is required to detect a signal in the state in which the terminal is not aware of information on the downlink control channel, and a search space indicating a set of CCEs may be defined for blind decoding. The search space is a set of candidate control channels including CCEs for which the terminal should attempt decoding at the given aggregation level. There are several aggregation levels at which a set of CCEs is configured by 1, 2, 4, 8, and 16 CCEs, so that the terminal has a plurality of search spaces. The search space set may be defined as a set of search spaces at all configured aggregation levels.

The search spaces may be classified into a common search space and a terminal (UE)-specific search space. According to an embodiment of the disclosure, terminals in a predetermined group or all terminals may search for a common search space of the PDCCH in order to receive cell-common control information such as dynamic scheduling of system information or paging messages.

For example, the terminal may receive PDSCH scheduling allocation information for transmission of an SIB including information on the service provider of a cell by searching a common search space of the PDCCH. In a case of the common search space, terminals in a predetermined group or all terminals should receive the PDCCH, so that the common search space may be defined as a set of pre-arranged CCEs. Scheduling allocation information of the terminal-specific PDSCH or PUSCH may be received by searching a terminal-specific search space of the PDCCH. The terminal-specific search space may be defined in a terminal-specific manner as a terminal identity and a function of various system parameters.

In the 5G system, parameters for the PDCCH search space may be configured for the terminal by the base station via higher-layer signaling (for example, SIB, MIB, or RRC signaling). For example, the base station may configure, for the terminal, the number of PDCCH candidates at each aggregation level L, a monitoring period of the search space, a monitoring occasion in units of symbols within the slot for the search space, a search space type (a common search space or a terminal-specific search space), a combination of a DCI format and an RNTI to be monitored in the corresponding search space, a control resource set index for monitoring the search space, and the like. For example, the above-described configuration may include the following information as shown in [Table 10].

TABLE 10

| | |
|---|---|
| SearchSpace ::= | SEQUENCE { |

```
  -- Identity of the search space. SearchSpaceId = 0 identifies the SearchSpace configured via PBCH
    (MIB) or ServingCellConfigCommon.
```

| | |
|---|---|
| searchSpaceId | SearchSpaceId, |

(search space identifier)

| | |
|---|---|
| controlResourceSetId | ControlResourceSetId, |

(control resource set identifier)

| | |
|---|---|
| monitoringSlotPeriodicityAndOffset | CHOICE { |

(monitoring slot level period)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |
| } | |
| duration(monitoring duration) | INTEGER (2..2559) |
| monitoringSymbolsWithinSlot | BIT STRING (SIZE (14)) |

(monitoring symbols in slot)

| | |
|---|---|
| nrofCandidates | SEQUENCE { |

(the number of PDCCH candidate groups for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

},

| | |
|---|---|
| searchSpaceType | CHOICE { |

```
  (search space type)
    -- Configures this search space as common search space (CSS) and DCI formats to monitor.
```

| | |
|---|---|
| common | SEQUENCE { |

```
  (common search space)
  }
```

| | |
|---|---|
| ue-Specific | SEQUENCE { |

```
  (UE-specific search space)
    -- Indicates whether the UE monitors in this USS for DCI formats 0-0 and 1-0 or for formats 0-1
    and 1-1.
```

| | |
|---|---|
| formats | ENUMERATED {formats0-0-And-1-0, formats0-1- |

```
    And-1-1},
    ...
    }
```

The base station may configure one or a plurality of search space sets for the terminal according to the configuration information. In an embodiment of the disclosure, the base station may configure search space set 1 and search space 2 for the terminal, and the configuration may be performed such that DCI format A scrambled by an X-RNTI in search space set 1 is monitored in the common search space and DCI format B scrambled by a Y-RNTI in search space set 2 is monitored in the terminal-specific search space.

According to the configuration information, there may be one or a plurality of search space sets in the common search space or the terminal-specific search space. For example, search space set #1 and search space set #2 may be configured as common search spaces, and search space set #3 and search space set #4 may be configured as terminal-specific search spaces.

The common search spaces may be classified into a particular type of search space sets according to the purpose thereof. RNTIs to be monitored may be different for each determined search space set type. For example, the common search space types, the purposes, and the RNTIs to be monitored may be classified as shown in Table 10a below.

TABLE 10a

| Search | | |
|---|---|---|
| space type | Purpose | RNTI |
| Type0 CSS | PDCCH transmission for SIB scheduling | SI-RNTI |
| Type0A CSS | PDCCH transmission for SI scheduling | SI-RNTI |
| | (SIB2, etc.) other than SIB1 | |
| Type1 CSS | PDCCH transmission for random-access | RA-RNTI, |
| | response (RAR) scheduling, Msg3 | TC-RNTI |
| | retransmission scheduling, and Msg4 | |
| | scheduling | |
| Type2 CSS | Paging | P-RNTI |
| Type3 CSS | Group control information transmission | INT-RNTI, |
| | | SFI-RNTI, |
| | | TPC-PUSCH-RNTI, |
| | | TPC-PUCCH-RNTI, |
| | | TPC-SRS-RNTI |
| | PDCCH transmission for data scheduling | C-RNTI, |
| | in case of PCell | MCS-C-RNTI, |
| | | CS-RNTI |

In a common search space, the following combinations of a DCI format and a RNTI may be monitored, but is not limited to the examples below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a terminal-specific search space, the following combinations of a DCI format and a RNTI may be monitored, but is not limited to the examples below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The described types of RNTIs may follow the definitions and purposes below.

Cell RNTI (C-RNTI): Terminal-specific PDSCH scheduling purpose

Temporary Cell RNTI (TC-RNTI): Terminal-specific PDSCH scheduling purpose

Configured Scheduling RNTI (CS-RNTI): Semi-statically configured terminal-specific PDSCH scheduling purpose

Random Access RNTI (RA-RNTI): The purpose of scheduling a PDSCH in a random access stage

Paging RNTI (P-RNTI): The purpose of scheduling a PDSCH on which paging is transmitted

System Information RNTI (SI-RNTI): The purpose of scheduling a PDSCH on which system information is transmitted

Interruption RNTI (INT-RNTI): The purpose of notifying of whether a PDSCH is punctured

Transmit Power Control for PUSCH RNTI (TPC-PUSCH-RNTI): The purpose of indicating a power control command for a PUSCH

Transmit Power Control for PUCCH RNTI (TPC-PUCCH-RNTI): The purpose of indicating a power control command for a PUCCH

Transmit Power Control for SRS RNTI (TPC-SRS-RNTI): The purpose of indicating a power control command for a SRS

In an embodiment, the described DCI formats may follow the definitions in [Table 11] below.

TABLE 11

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In the 5G system, a search space of aggregation level L in control resource set p and search space set s may be expressed as in the following equation.

$$\\ \begin{matrix}L \cdot \{ ( {Y}_{p , {n}_{s , f}^{{}^{} μ}} + ⌊ \frac{{m}_{s , {n}_{CI}} \cdot {N}_{CCE , p}}{L \cdot {M}_{p , s , max}^{{}^{} ( L )}} ⌋ + {n}_{CI} ) mod ⌊ {N}_{CCE , p} / L ⌋ \} + i & [ Equation 2 ]\end{matrix}$$

L: Aggregation level
n_{CI}: Carrier index
N_{CCE,p}: The total number of CCEs existing in control resource set p
n^{μ}_{s,f}: Slot index
M^{(L)}_{p,s,max}: The number of PDCCH candidate groups of aggregation level L
m_{snCI}=0, . . . , M^{(L)}_{p,s,max}−1: The index of PDCCH candidate groups of aggregation level L
i=0, . . . , L−1
Y_{p,n}_{_{s,f}}μ=(Aₚ·Y_{p,n}_{_{s,f}}μ₋)mod D, Y_{p,-1}=n_{RNTI}≠0, A₀=39827, A₁=39829, A₂=39839, D=65537
n_{RNTI}: Terminal identifier

In a case of a common search space, Y_(p,n^{μ}_{s,f}) may be 0.

In a case of a terminal-specific search space, Y_(p,n^{μ}_{s,f}) may be changed according to a time index and the identity (a C-RNTI or an ID configured for the terminal by the base station) of a terminal.

According to an embodiment of the disclosure, a plurality of search space sets may be configured as different parameters (for example, the parameters in [Table 10]) in the 5G system. Accordingly, the search space set that the terminal monitors may be different each time. For example, when search space set #1 is configured in an X-slot period, search space set #2 is configured in a Y-slot period, and X and Y are different from each other, the terminal may monitor both search space set #1 and search space set #2 in a particular slot, and may monitor only one of search space set #1 and search space set #2 in another particular slot.

Meanwhile, the uplink/downlink HARQ in the NR system adopts an asynchronous HARQ scheme in which the data retransmission time point is not fixed. By taking the downlink as an example, when a base station has received a feedback of HARQ NACK from the terminal in response to initially transmitted data, the base station freely determines the retransmission data transmission time point according to a scheduling operation. After buffering data that has been determined as an error as a result of decoding of reception data for an HARQ operation, the terminal may perform combining with the next retransmission data. HARQ ACK/NACK information of the PDSCH transmitted in a subframe n-k may be transmitted from the terminal to the base station via the PUCCH or the PUSCH in a subframe n. In the 5G communication system such as the NR system, a k value may be included in DCI for indicating or scheduling reception of the PDSCH transmitted in the subframe n-k and then transmitted, or may be configured for the terminal via a higher-layer signal. In this case, the base station may configure one or more k values via a higher-layer signal, and may indicate a particular k value via the DCI, wherein k may be determined based on HARQ-ACK processing capacity of the terminal, i.e., a minimum time required for the terminal to receive the PDSCH and then to generate and report HARQ-ACK with respect to the PDSCH. In addition, before the k value is configured for the terminal, the terminal may use a pre-defined value or a default value.

Next, the description of a resource area in which a data channel is transmitted in a 5G communication system will be made below.

FIG. 5 illustrates a resource area in which a data channel is transmitted in a 5G communication system. In a downlink control channel (hereinafter, referred to as a “PDCCH”) area (hereinafter, referred to as a “control resource set (CORESET)” or a “search space (SS)”) configured by the base station through a higher-layer signal, the terminal monitors or searches for a PDCCH 510. In this case, the downlink control channel area may include time-domain information 514 and frequency-domain information 512, the time-domain information 514 may be configured in units of symbols, and the frequency-domain information 512 may be configured in units of RBs or RB groups. When the terminal detects the PDCCH 510 in a slot i 500, the terminal acquires downlink control information (DCI) transmitted via the detected PDCCH 510. The terminal may acquire scheduling information relating to a downlink data channel or an uplink data channel from the received downlink control information (DCI). In other words, the DCI may include at least information on a resource area (or a PDSCH transmission area) in which the terminal is to receive a downlink data channel (hereinafter, referred to as a “PDSCH”) transmitted from the base station, or information on a resource area that is allocated to the terminal, by the base station, for transmission of an uplink data channel (a PUSCH). The case in which uplink data channel (PUSCH) transmission is scheduled for the terminal will be described as follows. The terminal that received DCI may acquire, from the DCI, a slot index or offset information K relating to reception of the PUSCH, and may determine a PUSCH transmission slot index. For example, the terminal may determine that the terminal is scheduled to transmit the PUSCH in a slot i+K 505, based on the offset information K, with reference to the slot index I 500 in which the PDCCH 510 is received. In this case, the terminal may also determine the slot i+K 505 or a PUSCH start symbol or time in the slot i+K by using the received offset information K, with reference to the received CORESET in which the PDCCH 510 is received. In addition, the terminal may acquire, from the DCI, information relating to a PUSCH transmission time-frequency resource area 540 in a PUSCH transmission slot 505, wherein PUSCH transmission frequency resource area information 530 may be information in units of PRBs or PRB groups. The PUSCH transmission frequency resource area information 530 is an area included in an initial (uplink) bandwidth (BW) 535 or an initial (uplink) bandwidth part (BWP) 535 that is determined by or is configured for the terminal via an initial access procedure. When a BW or a BWP is configured for the terminal via a higher-layer signal, the PUSCH transmission frequency resource area information 530 may be an area included in the BW or the BWP that is configured via the higher-layer signal.

The PUSCH transmission time resource area information 525 may be information in units of symbols or symbol groups, or may be information indicating absolute time information. In this case, the PUSCH transmission time resource area information 525 may be expressed as a combination of a PUSCH transmission start time or symbol and a PUSCH length, and a PUSCH end time or symbol, and may be included in the DCI as a field or value. Here, the PUSCH transmission time resource area information 525 may be included in the DCI as a field or a value expressing each of the PUSCH transmission start time or symbol and the PUSCH length, and the PUSCH end time or symbol. The terminal may transmit the PUSCH in a PUSCH transmission resource area 540 determined based on the DCI.

The description of a frequency-domain resource allocation scheme for a data channel in the 5G communication system will be made below.

The 5G system supports three types of frequency-domain resource allocation schemes for a physical downlink shared channel (PDSCH) and a physical uplink shared channel (PUSCH), namely resource allocation type 0, resource allocation type 1, and resource allocation type 2.

### Resource Allocation Type 0

RB allocation information may be notified of to the terminal in the form of a bitmap for a resource block group (RBG) by the base station. In this case, the RBG may include a set of consecutive virtual RBs (VRBs), and the RBG size P may be determined as a value configured with a high-layer parameter (rbg-Size) and a value of a bandwidth part size defined in the table below.

TABLE 12

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The total number N_{RBG} of RBGs of bandwidth part i having the size of N_{BWP,i}^{size} may be defined as below:
   N_{RBG}┌(N_{BWP,i}^{size}+(N_{BWP,i}^{start}modP))/P┐, where
      the size of the first RBG is RBG₀^{size}=P−N_{BWP,i}^{start}modP,
      the size of last RBG is RBGₗₐₛₜ^{size}=(N_{BWP,i}^{start}+N_{BWP,i}^{size})modP if (N_{BWP,i}^{start}+N_{BWP,i}^{size})modP>0 and P otherwise,
      the size of all other RBGs is P.
Each bit of a bitmap having the size of NRBG bit may correspond to each of the RBGs. The RBGs may be indexed in the order of the ascending frequency, starting from the lowest frequency position of the bandwidth part. With respect to NRBG RBGs in the bandwidth part, RBG#0 to RBG#(N_{RBG}−1) may be mapped to MSB to LSB of an RBG bitmap. When a particular bit value in the bitmap is 1,the terminal may determine that an RBG corresponding to the bit value is allocated, and when a particular bit value in the bitmap is 0, the terminal may determine that an RBG corresponding to the bit value is not allocated.

### Resource Allocation Type 1

Start positions and lengths of consecutively allocated VRBs may be notified of to the terminal as RB allocation information by the base station. In this case, interleaving or non-interleaving of the consecutively allocated VRBs may be additionally applied. A resource allocation field of resource allocation type 1 may be configured with a resource indication value (RIV), wherein the RIV may include a start point RBₛₜₐᵣₜ of a VRB and the lengths L_{RBs} of consecutively allocated RBs. More specifically, the RIV in the bandwidth part of the size N_{BWP}^{size} may be defined as follows:

| | |
|---|---|
| ▪ | if (L_{RBs} − 1) ≤ └N_{BWP}^{size} / 2┘ then |
| | ♦ RIV = N_{BWP}^{size} (L_{RBs} − 1) + RBₛₜₐᵣₜ |
| ▪ | else |
| | ♦ RIV = N_{BWP}^{size} (N_{BWP}^{size} − L_{RBs} + 1) + (N_{BWP}^{size} − 1 − RBₛₜₐᵣₜ ) |
| ▪ | where L_{RBs} ≥ 1 and shall not exceed N_{BWP}^{size} − RBₛₜₐᵣₜ. |

### Resource Allocation Type 2

M interlace index sets may be notified of to the terminal as RB allocation information by the base station.
Interlace index in m∈{0, 1, . . . , M−1} may be configured by common RBs {m,M+m,2 M+m,3 M+m, . . . }, and M may be defined as shown in Table 13 below.

TABLE 13

| μ | M |
|---|---|
| 0 | 10 |
| 1 | 5 |

The relationships between the common RB n_{CRB}^{μ} and the RB n_{IRB,m}^{μ}┌{0, 1,, . . . } in the interlace m and the bandwidth part i may be defined as below:
n_{CRB}^{μ}=Mn_{IRB,m}^{μ}+N_{BWP,i}^{start,μ}+((m−N_{BWP,i}^{start,μ}) mod M)
where N_{BWP,i}^{start,μ} is the common resource block where the bandwidth part starts relative to common resource block 0. u is subcarrier spacing index
When a subcarrier spacing is 15 kHz (u=0), m₀+1 indices may be notified of to the terminal as the RB allocation information relating to the interlace set by the base station. In addition, a resource allocation field may be configured by resource indication value (RIV). When the RIV is 0≤RIV<M(M+1)/2, l=0, 1, . . . L−1, the resource allocation field may be configured by start interlace m₀ and the number of consecutive interlaces L (L≥1), and the value is as follows:

if (L−1) ≤ └ M/2 ┘ then
RIV=M(L−1)+m₀
else
RIV=M(M−L+1)+(M−1−m₀)

When the RIV is RIV≥M(M+1)/2, the RIV may be configured by values of start interlace index m₀ and 1, and the value may be configured as shown in Table 14.

TABLE 14

| RIV − M(M + 1)/2 | m₀ | l |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

When a subcarrier spacing is 30 kHz (u=1), the RB allocation information may be notified of to the terminal in the form of a bitmap indicating interlaces allocated to the terminal, by the base station. The bitmap size is M, and 1 bit of the bitmap corresponds to each interlace. With respect to the interlace bitmap order, interlace indices 0 to M−1 may be mapped to MSB to LSB.

In addition, with respect to 15 kHz and 30 kHz, a least significant bit (LSB) Y=┌log2 (N_(RB-set)\hat{ }BWP (N_(RB-set)\hat{ }BWP+1))/2 of an FDRA field may mean a set of consecutive RBs of the PUSCH scheduled by DCI format 0_1. Y bit may be configured by a resource indication value (RIV_{RBset}). In 0≤RIV_{RBset}<N_{RB-set}^{BWP}(N_{RB-set}^{BWP}+1)/2, l=0, 1, . . . L_{RBset}−1, RIV_{RBset} may be determined by a start RB set RBset_{START} and the number L_{RBset}(L_{RBset}≥1) of consecutive RB sets. RIV_{RBset} may be defined as follows:

if (L_{RBset}− 1)≤ └ N_{RB-set}^{BWP}/2 ┘ then
RIB_{RBset}= N_{RB-set}^{BWP}(L_{RBset}− 1)+RBset_{START}
else
RIV_{RBset}=N_{RB-set}^{BWP}(N_{RB-set}^{BWP}−L_{RBset}+1)+(N_{RB-set}^{BWP}−1−RBset_{START})

N_{RB-set}^{BWP} means a number of RB sets included in the BWP, and may be determined by the number of guard gaps (or bands) in a carrier preconfigured or configured via higher-layer signaling.

Meanwhile, in the NR system, a preparation time for PUSCH transmission after the terminal is scheduled to transmit the PUSCH is defined. When the PUSCH first symbol including a DMRS is scheduled to the terminal by the base station after L2, the terminal may transmit the PUSCH, or may disregard scheduling DCI. Here, L2 means the first uplink symbol where CP starts after T_{proc,2}=max((N₂+d_{2,1})(2048+144)·κ2^{-μ}·T_{C}, d_{2,2}) from the last symbol of the PDCCH including DCI for scheduling the PUSCH.
N₂ may be defined as shown in Tables 15A and 15B. u is determined by a value having a greater T_{proc,2}, among u_{DL} and u_{UL}, wherein u_{DL} and u_{UL} mean a PDCCH subcarrier spacing and a PUSCH subcarrier spacing, respectively. In addition, κ=TₛT_{c}=64, Tₛ=1/(Δf_{ref}·N_{f,ref}), T_{c}=1/(Δfₘₐₓ·N_{f}), N_{f}=4096, and N_{f,ref}=2048.
If the first symbol of the PUSCH is configured by only a DM-RS, d_{2,1}=0, else d_{2,1}=1.
If the DCI instructs BWP switching, d2,2 means a BWP switching time, else d_{2,2}=0.

TABLE 15a

| μ | PUSCH preparation time N₂ [symbols] |
|---|---|
| 0 | 10 |
| 1 | 12 |
| 2 | 23 |
| 3 | 36 |

TABLE 15b

| μ | PUSCH preparation time N₂ [symbols] |
|---|---|
| 0 | 5 |
| 1 | 5.5 |
| 2 | 11 for frequency range 1 |

Next, a scheme of configuring a beam to transmit control information and data to the terminal by the base station will be described. For convenience of description in the disclosure, a process of transmitting control information via a PDCCH may be represented in that a PDCCH is transmitted, and a process of transmitting data via a PDSCH may be represented in that a PDSCH is transmitted.

First, a beam configuration scheme will be described.

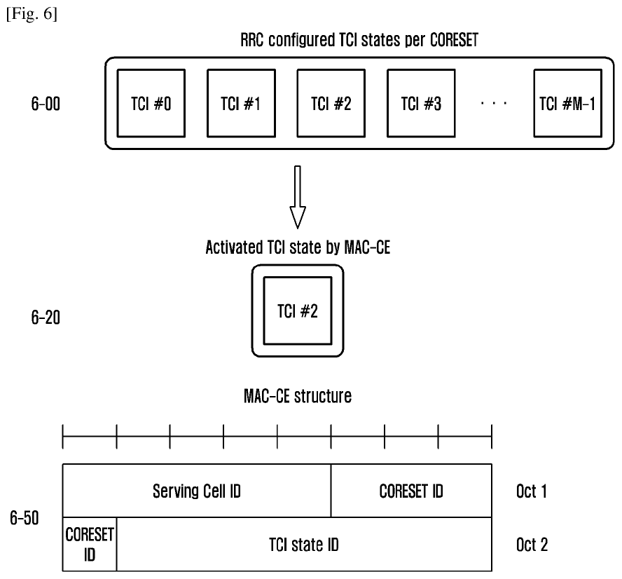

FIG. 6 illustrates a process of beam configuration and activation for a PDCCH according to an embodiment of the disclosure. First, a list of TCI states may be indicated for each CORESET through a higher-layer list such as RRC (operation 6-00). The list of TCI states may be indicated by “tci-StatesPDCCH-ToAddList” and/or “tci-StatesPDCCH-ToReleaseList”. Next, one from the list of TCI states configured for each CORESET may be activated by the MAC-CE (operation 6-20). Operation 6-50 illustrates an example of a MAC-CE structure for TCI state activation. The meaning of each field and a value configured for each field in the MAC-CE are as follows.

Serving Cell Identifier (Serving Cell ID): This field indicates
the identity of the Serving Cell for which the MAC CE applies.
The length of the field is 5 bits;
CORESET Identifier (CORESET ID): This field indicates a Control
Resource Set identified with ControlResourceSetId as specified in
TS 38.331 [5], for which the TCI State is being indicated. In case
the value of the field is 0, the field refers to the Control
Resource Set configured by controlResourceSetZero as specified in
TS 38.331 [5]. The length of the field is 4 bits;
Transmssion control indication Identifier (TCI State ID): This
field indicates the TCI state identified by TCI-StateId as specified
in TS 38.331 [5] applicable to the Control Resource Set identified by
CORESET ID field. If the field of CORESET ID is set to 0, this field
indicates a TCI-StateId for a TCI state of the first 64 TCI-states
configured by tci-States-ToAddModList and tci-States-ToReleaseList
in the PDSCH-Config in the active BWP. If the field of CORESET ID
is set to the other value than 0, this field indicates a TCI-StateId
configured by tci-StatesPDCCH-ToAddList and tci-StatesPDCCH-
ToReleaseList in the controlResourceSet identified by the indicated
CORESET ID. The length of the field is 7 bits.

Next, a scheme of configuring a beam for a PDSCH will be described.

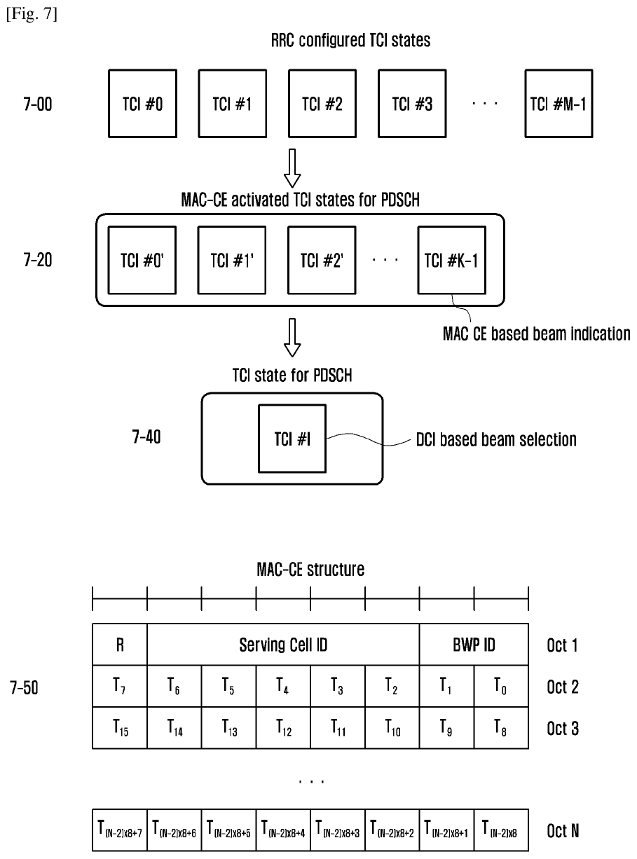

FIG. 7 illustrates a process of beam configuration and activation for a PDSCH according to an embodiment of the disclosure.

First, a list of TCI states may be indicated through a higher-layer list such as RRC (operation 7-00). The list of TCI states may be indicated by, for example, “tci-StatesToAddModList” and/or “tci-StatesToReleaseList” in a PDSCH-Config IE for each BWP. Next, some of the list of TCI states may be activated by the MAC-CE (operation 7-20). The maximum number of the activated TCI states may be determined according to the capability reported by the terminal. Operation 7-50 illustrates an example of a MAC-CE structure for TCI state activation/deactivation of a Rel-15-based PDSCH.

The meaning of each field and a value configured for each field in the MAC-CE are as follows.

Serving Cell Identifier (Serving Cell ID): This field indicates
the identity of the Serving Cell for which the MAC CE applies.
The length of the field is 5 bits;
Bandwidth Part Identifier (BWP ID): This field indicates a DL BWP
for which the MAC CE applies as the codepoint of the DCI bandwidth
part indicator field as specified in TS 38.212 [9]. The length of
the BWP ID field is 2 bits;
TCI state Identifier i (Ti): If there is a TCI state with TCI-
StateId i as specified in TS 38.331 [5], this field indicates the
activation/deactivation status of the TCI state with TCI-StateId i,
otherwise MAC entity shall ignore the Ti field. The Ti field is set
to 1 to indicate that the TCI state with TCI-StateId i shall be
activated and mapped to the codepoint of the DCI Transmission
Configuration Indication field, as specified in TS 38.214 [7].
The Ti field is set to 0 to indicate that the TCI state with TCI-
StateId i shall be deactivated and is not mapped to the codepoint of
the DCI Transmission Configuration Indication field. The codepoint to
which the TCI State is mapped is determined by its ordinal position
among all the TCI States with Ti field set to 1, i.e. the first TCI
State with Ti field set to 1 shall be mapped to the codepoint value
0, second TCI State with Ti field set to 1 shall be mapped to the
codepoint value 1 and so on. The maximum number of activated TCI
states is 8;
Reserved Bit (R): Reserved bit, set to 0.

When the terminal has received DCI format 1_1 or DCI format 1_2, the terminal may receive, based on transmission configuration indication (TCI) field information in the DCI, a PDSCH by a beam of TCI states activated by the MAC-CE (operation 7-40). Whether the TCI field exists may be determined by a tci-PresentinDCI value indicating a higher-layer parameter in a CORESET configured to reception of the DCI. When tci-PresentinDCI is configured to be “enabled” in the higher layer, the terminal may identify a TCI field having 3-bit information and determine the TCI states activated in the DL BWP or the scheduled component carrier and the direction of a beam associated with the DL-RS.

In the LTE and NR system, in the state in which the terminal is connected to the serving base station, a procedure of reporting the capability supported by the terminal to the corresponding base station is performed. In the following description, the procedure may be referred to as “UE capability (report)”. The base station may transfer a UE capability enquiry message requesting the capability report to the terminal in the connection state. The message may include a UE capability requested by the base station for each RAT type. The request for each RAT type may include required frequency band information. In addition, multiple RAT types may be request through the UE capability enquire message in one RRC message container, or multiple UE capability enquire messages including a request for each RAT type may be transferred to the terminal. That is, the UE capability enquiry may be repeated multiple times, and the terminal may configure the UE capability information message relating to the enquiry and report the message multiple times. In the next-generation mobile communication system, the UE capability request for NR, LTE, EN-DC, and MR-DC can be made. Generally, the UE capability enquiry message is initially transmitted after the terminal is connected, but the base station may request the message as necessary in some conditions.

In the above operation, the terminal having received the UE capability report request from the base station configures the terminal (UE) capability according to the RAT type or band information request by the base station. A scheme of configuring UE capability by the terminal in the NR system is described as below:

1. When the terminal receives a list relating to the LTE and/or NR band upon the UE capability request from the base station, the terminal configures a band combination (BC) for EN-DC and NR stand-alone (SA). That is, the terminal configures, based on the bands requested from the base station through FreqBandList, a candidate list of BCs for EN-DC and NR SA. In addition, the bands have priorities as in the order listed in FreqBandList.

2. When the base station sets an “eutra-nr-only” flag or an “eutra” flag and requests a UE capability report, the terminal completely removes NR SA BCs from the above-configured candidate list of BCs. This operation can be performed when the LTE base station (eNB) request “eutra” capability.

3. Later, the terminal removes fallback BCs from the candidate list of BCs configured in the above operation. In this case, if the fallback BC corresponds to a super set BC from which a band corresponding to one initial SCell is removed, and the super set BC can cover the fallback BC already, the fallback BC can be omitted. This operation is applied to the MR-DC, that is, the LTE bands. The remaining BCs after this operation correspond to the final “candidate BC list”.

4. The terminal selects BCs suitable for the request RAT type from the final “candidate BC list” and selects BCs to be reported. In this operation, the terminal configures supportedBandCombinationList according to a predetermined order. That is, the terminal configures the UE capability and BC to be reported according to a pre-configured rat-Type order. (nr→eutra-nr→eutra). In addition, the terminal configures featureSetCombination for the configured supportedBandCombinationList and configures a “candidate feature set combination” list from the candidate BC list from which a list of the fallback BCs (including the capability in the level equal to or lower than those of the other BCs) is removed. The “candidate feature set combination” includes all feature set combinations for the NR and EUTRA-NR BC, and may be acquired from the feature set combination of the UE-NR-Capabilities and UE-MRDC-Capabilities container.

5. In addition, when the request RAT type is “eutra-nr” and affects, featureSetCombinations are included in both containers of UE-MRDC-Capabilities and UE-NR-Capabilities. However, the feature set of the NR is included only in the UE-NR-Capabilities.

Once the terminal (UE) capability is configured, the terminal transfers a UE capability information message including the UE capability to the base station. The base station performs, based on the UE capability received from the terminal, scheduling and reception or transmission management suitable for the corresponding terminal later.

As a part of further enhancement of the existing Rel.16 of the 5^{th} generation (5G) new radio (NR) mobile communication system, in Rel. 17, control and data channel transmissions are being redesigned for better reliability and performance it can be referred to the 3GPP RANI work item document (WID) for Rel-17 further-enhanced multiple input multiple output (FeMIMO). One such enhancement is multiple transmission reception point (mTRP)-based reliability enhancement for physical downlink control channel (PDCCH). The enhancement focuses on improving the reliability of PDCCH by transmitting the same downlink control information (DCI) from multiple TRPs (mTRP) via different multiplexing schemes. Similarly, further enhancement on the reliability of uplink control information (UCI) transmission is being considered by allowing a UE to transmit its UCI towards multiple TRPs over repeated (in time domain) physical uplink control channel (PUCCH) transmissions.

In contrast to the 4G mobile communication system, long-term evolution (LTE), which is deployed over the sub 6 GHz bands, NR considers both the sub 6 GHz and above 6 GHz bands which are referred to as FR1 and FR2, respectively. Owing to the severe pathloss in higher frequency bands and in order to compensate this loss, operations in FR2 require concentration of the transmitted power in a certain spatial direction by performing beamforming. In this regard, the availability of massive number of antennas, dubbed as massive multiple input multiple output (mMIMO), at the gNBs, allow narrow beams which can direct the transmitted power towards the UE. Similarly, UEs equipped with multiple antennas perform beamforming in their uplink transmission. In the Rel. 15 and 16, beams to be employed for the reception of the downlink and uplink transmission are indicated to the UE by means of transmission configuration indication (TCI) and spatial relation information, respectively.

As transmission power is directed to a certain spatial direction via beamforming, in NR, uplink power control is also closely related to the applied beamforming. In fact, in Rel. 16 NR, for PUCCH transmission on active UL bandwidth part (BWP) b of carrier f in the primary cell c using the PUCCH power control adjustment with index l, the UE determines the PUCCH transmission power in PUCCH transmission occasion i as disclosed in 3GPP TS 38.214 as

$$\\ \begin{matrix}{P}_{PUCCH , b , f , c} ( i , {q}_{n} , {q}_{d} , l ) = min \{ \begin{matrix}{P}_{CMAX , f , c} ( i ) , \\ {P}_{0 \_ PUCCH , b , f , c ( {q}_{u} )} + 10 {log}_{10} ( {2}^{μ} {M}_{RB , b , f , c}^{{}^{} PUCCH} ( i ) ) + {PL}_{b , f , c} ( {q}_{d} ) + \\ {Δ}_{F \_ PUCCH} ( F ) + {Δ}_{TF , b , f , c} ( i ) + {g}_{b , f , c} ( i , l )\end{matrix} [ dBm ] & ( 1 )\end{matrix}$$

where P_{CMAX,f,c,}(i) is the UE configured maximum output power, P_{0_PUCCH,b,f,c(q}_{_{μ}}₎ is a target power parameter composed of nominal and UE-specific parameters, M_{RB,b,f,c}^{PUCCH}(i) is a bandwidth of PUCCH resource assignment expressed in number of resource blocks (RBs), Δ_{F_PUCCH}(F) and Δ_{TF,b,f,v}(i) are power adjustment parameters based on the PUCCH formats and g_{b,f,c}(i,l) is a closed-loop transmission power control (TPC) command. Moreover, PL_{b,f,c}(q_{d}) is a power compensation based on downlink pathloss (PL) estimated in dB by the UE from a pathloss reference signal (PL-RS) with resource index q_{d}. It should be noted that the downlink PL-RS for PL estimation could be a beamformed RS so that accurate PL in a certain direction is measured. It can also be observed that it is optimum if PLRS is chosen in such a way that the spatial setting (beam) to receive it is the same with the uplink beam for transmission of PUCCH, so that accurate compensation of PL be performed. Consequently, in Rel-15 and 16, under normal operations, i.e., when radio resource control (RRC) is configured and uplink spatial relation is provided, the PL-RS is chosen as a periodic reference signal with the same spatial property as the intended PUCCH transmission.

In order to reduce the overhead and latency incurred by the separate indication of uplink and downlink beam information, Rel. 16 introduced default behaviour for the UE with respect to the spatial relation and PLRS to be applied for sounding reference signal (SRS) and PUCCH. This makes more sense as uplink spatial relation information is anyway derived from a downlink beam (reference signal). Moreover, in many cases, the best beam to receive a downlink transmission is also the best beam for uplink transmission. Therefore, it is natural for uplink transmission such as PUCCH, PUSCH and SRS to follow the beam indicated for downlink transmission.

The principal object of the embodiments herein is to disclose methods and apparatus for selecting the default beam, or the transmitter spatial filter, upon transmission of PUCCH in communication networks, wherein the communication network is at least one of the Fifth Generation (5G) standalone network and a 5G non-standalone (NAS) network.

Another object of the embodiments herein is to disclose methods and systems for selecting the default PLRS for measurement of pathloss upon transmission of PUCCH in 5G communication network.

Another object of this embodiment herein is to disclose methods and apparatus for selecting default beam and default PLRS upon PUCCH repetitions intended for multiple transmit receive points (mTRP).

Accordingly, the embodiments herein provide methods and apparatus for selecting the default beam and PL-RS for the transmission of PUCCH in 5G communication networks. A method disclosed herein describes a UE-side process of acquiring the default beam and PL-RS for transmission of PUCCH. Similarly, a method disclosed herein describes the gNodeB (gNB)-side process for configuring default beam for transmission of PUCCH. The present disclosure considers two scenarios for the behaviour of a UE on selecting the default beam and PLRS for the transmission of PUCCH. The two scenarios included in this disclosure are the scenario wherein the received physical downlink control channel (PDCCH) is in a same-frequency network (SFN) manner and the scenario wherein the received PDCCH is in a non-same frequency network (non-SFN) manner. In particular, methods are disclosed to select a single or multitude of default beams that can be applied at least to the situation where the PUCCH transmission is intended for mTRP operation.

In the first scenario, i.e., when PDCCH is received in an SFN manner, at least one method is disclosed on selecting a single default beam based on a single transmission configuration information (TCI) state of the received SFNed PDCCH transmission. Moreover, at least one method is also disclosed that combines the TCI states of the received PDCCH, to enable an SRS transmission towards multiple TRPs. Furthermore, multitude of methods are presented to select multiple default beams and PL-RS wherein each beam and PLRS is associated with a single TCI state among the multitude of TCI states associated in the SFNed PDCCH transmission. The method further describes how the multiple default beams and PL-RSs can be applied to multiple PUCCH repetitions by linking each beam and PL-RS to a corresponding PUCCH repetition beam.

Accordingly, in the second scenario, i.e., when PDCCH is received in a non-SFNed manner at least one method is disclosed on selecting a single default beam based on a single transmission configuration information (TCI) state of the received repetition of PDCCH transmissions. The non-SFN scenario considered herein includes both time domain multiplexing (TDM) and frequency domain multiplexing (FDM). Similarly, multitudes of methods are presented to select multiple default beams and PL-RSs based on the TCI states of TDMed or FDMed PDCCH transmissions. In this regard, the presented disclosure describes how the multiple default beams and PL-RSs can be applied to multiple SRS resource sets by linking each beam and PL-RS to a corresponding SRS resource set.

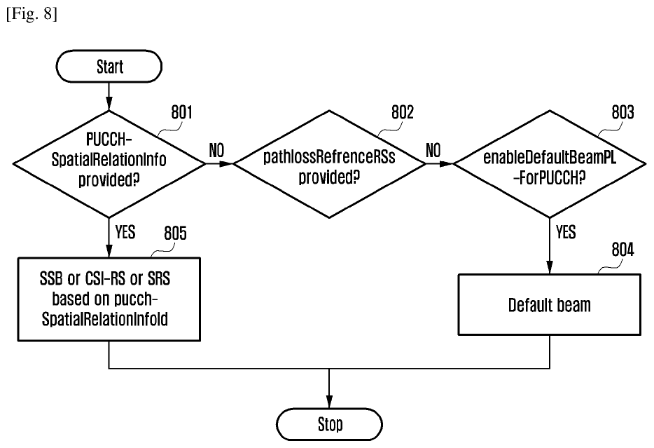

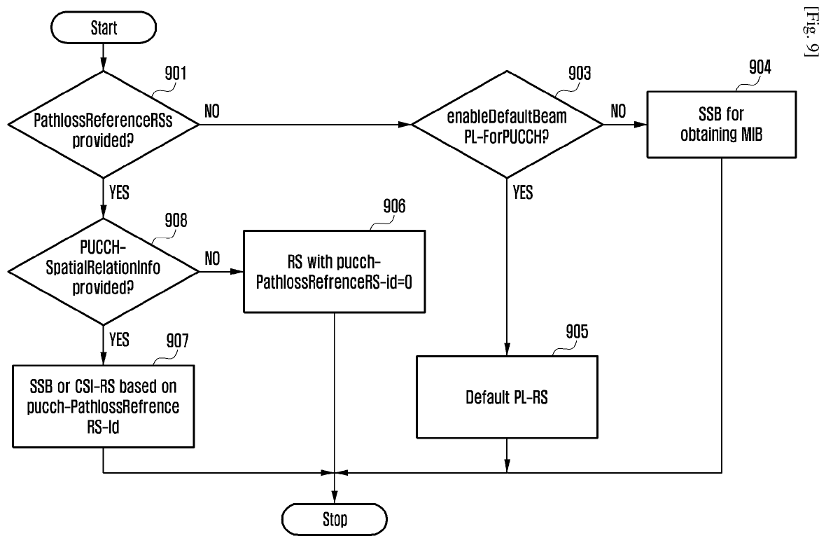

FIG. 8 illustrates a flowchart for the 5G release 16 communication network (Rel. 16) new radio (NR)-based beam (spatial setting) acquisition for PUCCH transmission.

In Rel-16 NR, the UE may derive the spatial relation information for PUCCH transmission from PUCCH-SpatialRelationInfo configured via RRC configuration which may consist a single or multiple pucch-SpatialRelationInfold values (801). Then for PUCCH transmission, a UE employs a same spatial domain filter as for a reception of either synchronization signal block (SSB) or channel state information measurement reference signal (CSI-RS) or a transmission of sounding reference signal (SRS), based on the index provided in pucch-SpatialRelationInfold (805). In case multiple pucch-SpatialRelationInfold are configured by RRC then one of them is activated via signalling in medium access control-control element (MAC-CE). When spatial relation is not explicitly configured, the UE can derive the default uplink beam for PUCCH transmission based on the TCI state of PDCCH associated to the CORESET with lowest index. In the FIG. 8 it is shown that if the PUCCH-SpatialRelationInfo (801) is not provided and if the RRC parameter enableDefaultBeamPLForPUCCH (803) is present (default beam is enabled), then the UE applies the default beam (804), i.e., a TCI state of the CORESET with lowest ID.

FIG. 9 illustrates a flowchart for the 5G release 16 communication network (Rel. 16) new radio (NR)-based PL-RS acquisition for PUCCH transmission.

Similarly, for pathloss compensation, the UE computes pathloss based on a PL-RS which is indicated by pucch-PathlossReferenceRS-id in the configured/activated pucch-SpatialRelationInfoID. As shown in FIG. 9, both SSB and CSI-RS (907) can be used as PUCCH PL-RS based on the indication by pucch-PathlossReferenceRS-id (908), if at least one PL-RS is provided (901). Moreover, before RRC configuration when PL-RS is not explicitly provided and default beam is not enabled, the UE employs the SSB it used to obtain MIB as a PL-RS (904). Otherwise, if both PL-RS is not provided (201) while enableDefaultBeamPL-ForPUCCH (903) is configured, i.e., default beam is enabled, the UE employs a periodic RS resource configured with qcl-Type set to ‘typeD’ in the TCI state or the QCL assumption of a CORESET with the lowest index in the active bandwidth part (905).

In order to enhance the reliability of DL and UL transmissions the mTRP-based repetition of PDSCH in Rel. 16 NR and PUCCH, PUSCH and PDCCH in Rel. 17 are considered. The repetition of the same DL/UL data or control information from/to mTRP makes the channels robust against blockage and provide macro diversity. In this regard, repetition towards two TRPs is considered in Rel. 16 and Rel. 17. However, this can be extended to more than 2 TRPs in the future.

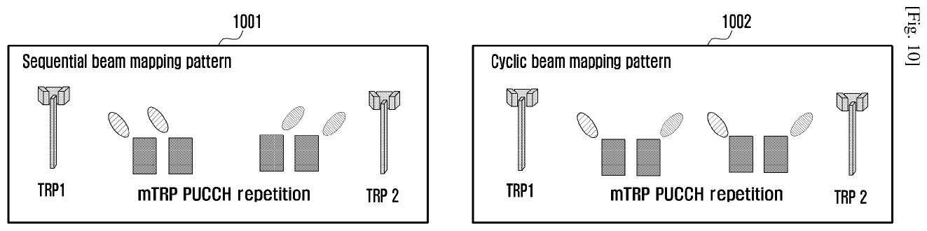

Consequently, mTRP PDCCH transmission is agreed to be included in Rel. 17 specification of NR based on both same frequency network (SFN) and non-SFN, i.e., time and frequency division multiplexing (TDM and FDM) schemes. Furthermore, upon writing of this document, up to 8 TDMed repetitions of PUCCH and PUSCH repetitions (with possibility of 16) is agreed to be allowed Rel. 17 NR. Consequently, based on the beam-to-repetition mapping pattern the two beams, used to transmit towards the two TRPs, can be employed in both sequential and cyclic manner. FIG. 10 illustrates sequential (1001) and cyclic (1002) beam mapping pattern for 4 PUCCH repetitions towards 2 TRPs.

There are two issues associated with the existing Rel. 16 NR in supporting mTRP-based PUCCH repetition.

Issue 1: As a result of the possibility of SFNed PDCCH transmission from mTRP, the existing method (NR Rel. 16) to derive a default spatial setting and PL-RS for PUCCH cannot directly be applied. This is a direct consequence of the existence of multiple TCI states associated to the SFNed CORESET with lowest ID. Therefore, it is required to resolve this ambiguity on selecting a certain TCI state from a set of TCI states.

Issue 2: For PUCCH repetition intended towards mTRPs, it is natural to select multiple default beams so that each beam is mapped to the PUCCH repetitions towards a corresponding TRP. Otherwise, if, for example, a single default PL-RS is selected based on only one TCI state (beam from a certain TRP), then the computed PL may not be accurate to compensate PL in PUCCH repetitions towards the remaining TRPs. Similarly, if a spatial setting is selected based on a single TCI states, then the PUCCH transmissions towards the remaining TRPs may not be correctly beamformed. Therefore, it is essential to consider multiple default beams for mTRP-based PUCCH repetitions. The prior art doesn't provide a means of deriving two default beams for mTRP PUCCH repetition.

This disclosure considers the behaviour of UE towards selecting default PLRS(s) and default spatial-relation setting(s) (beam) in scenarios wherein:

1) The PDCCH transmission is SFNed and multiple TCI states are associated to a CORESET with lowest ID.

2) The PUCCH repetition towards mTRP is performed

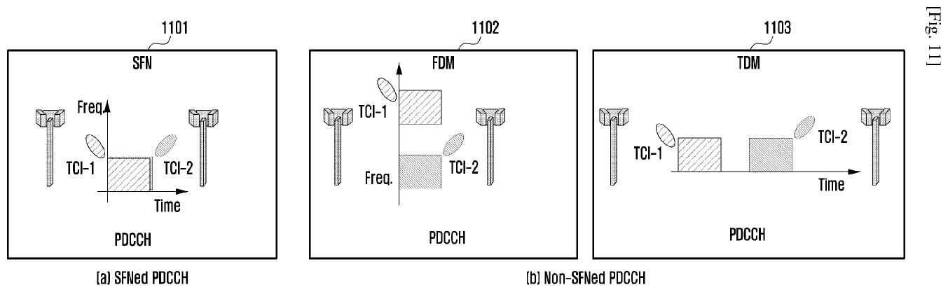

The below sections discuss two scenarios for PUCCH default beam behaviour considerations, i.e., PUCCH transmission setting and PL-RS for PUCCH. For each scenario, two PDCCH schemes, namely SFN scheme and Non-SFN scheme, are considered. FIG. 11 illustrates both SFN (1101) frequency domain multiplexed (FDM) (1102) and time domain multiplexed (TDM) (1103) PDCCH. And for each scheme in each scenario, multiple solutions are discussed for the default beam assumption of PUCCH, of which one or more solutions are applicable to a given scenario. Without loss of generality, the discussion below for the presented solutions is based on the currently agreed mTRP operation, i.e., PUCCH repetition towards two TRPs. In the last section, however, it is discussed that the presented solution can be extended to any arbitrary number of TRPs.

FIG. 11 illustrates an example of SFN and non-SFN-based PDCCH Transmission where two PDCCH are received in the TDM and FDM manner from two TRPs.

For SFNed PDCCH scheme, COREST used for PDCCH transmission is configured with more than one TCI states corresponding to different quasi co-location(QCL) parameters, where each PDCCH candidate of a monitored search space maps to at least one TCI state. Same PDCCH information is transmitted over the same time-frequency resource from each TRP. Upon reception of the PDCCH occasion, the UE performs channel estimation over the PDCCH demodulation reference signal(DM-RS) port considering a combined QCL parameter with respect to the configured TCI states. FIG. 11 (1101) illustrates SFNed PDCCH transmission.

For non-SFN scheme, the PDCCH transmission is monitored over more than one search space each associated with the respective control resource set (CORESET) with different transmission configuration indication (TCI) state corresponding to different quasi co-location(QCL) parameters. The same PDCCH information is transmitted over multiple transmission occasions from each TRP in different time resources as time division multiplexing (TDM) or in different frequency resources as frequency division multiplexing (FDM). Upon reception of the PDCCH occasions from different search spaces, the UE performs channel estimation over the PDCCH demodulation reference signal(DMRS) port considering different QCL parameters over each occasion, with respect to the configured TCI states. Diagram 1102 and 1103 in FIG. 11 illustrate non-SFNed PDCCH transmission.

In the following the general default beam acquisition process for the disclosed invention is presented. In this regard, we have detailed the process from the UE side and the base station (gNB) side. Moreover, the presented flowcharts are agnostic with the cases where the UE receives PDCCH in SFN and non-SFN manner, i.e., the flowcharts in this subsection apply for both cases.

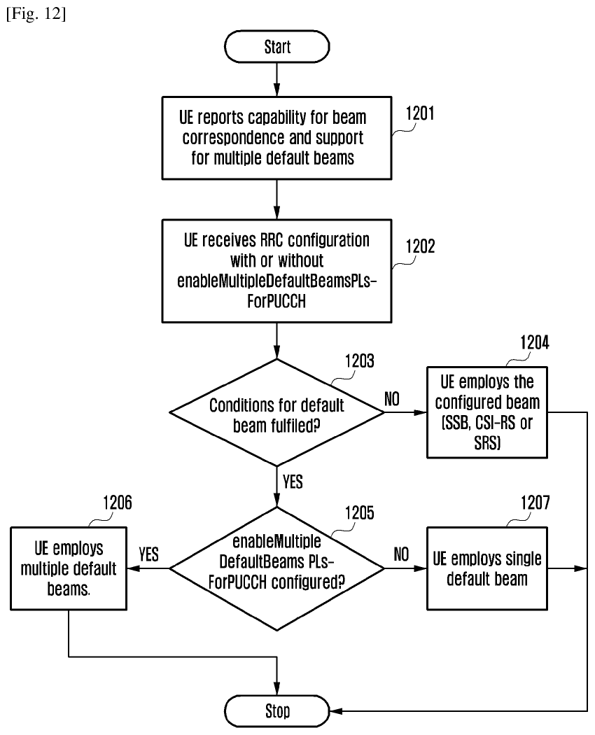

FIG. 12 illustrates a flowchart for the UE-side process of acquiring a default beam and PLRS for the transmission of PUCCH in the disclosed embodiments. FIG. 12 presents UE's process to acquire default beam for PUCCH transmission and the corresponding PL computation. Similar to the existing Rel. 16 scheme, a UE first reports it capability on (1201) whether it supports beam correspondence and multiple default beams. Upon reception of UE's capability report, the gNB the configures and hence the UE receives (1202) RRC configuration with or without enableMultipleDefault-BeamsPLs-ForPUCCH. enableMultipleDefaultBeamsPLs-ForPUCCH is a new RRC parameter that enables multiple default beams for transmission of PUCCH and the corresponding PL measurement. The UE then checks if the conditions for default beam are fulfilled based on the flowcharts and conditions thereof in FIG. 8 and FIG. 9. If the conditions are not fulfilled (1203), that means an explicit beam is either configured via RRC or activated via MAC-CE. In this case, the UE employs (1204) the explicitly configured beam based on the indicated RS index (SSB, CSI-RS or SRS). If the conditions for default beam are fulfilled (1203), the UE then checks if multiple default beams are enabled or not (1205). Finally, based on the configuration of enableMultipleDefaultBeamsPLs-ForPUCCH the UE applies either single (1207) or multiple (1206) default beams. The details of how to choose the default beams are presented in the following subsections. Finally, based on the configuration of enableMultipleDefaultBeamsPLs-ForSRS the UE applies either single (1207) or multiple (1206) default beams. The higher parameter enableMultipleDefaultBeamsPLs-ForPUCCH can be provided in RRC configuration under UplinkConfig:. Moreover, enableMultipleDefaultBeamsPLs-ForPUCCH shall be provided along with the higher parameter enableDefaultBeamPL-ForPUCCH so that multiple default beams can be considered by the UE. The details of how to choose the default beams are presented in the following subsections. The signalling structure in RRC to enable multiple default beams can be given as follows:

| | |
|---|---|
| UplinkConfig ::= | SEQUENCE { |
| initialUplinkBWP | BWP-UplinkDedicated OPTIONAL, |
| . | |
| . | |
| enableDefaultBeamPL-ForPUSCH0-0-r16 | ENUMERATED {enabled} OPTIONAL, |
| enableDefaultBeamPL-ForPUCCH-r16 | ENUMERATED {enabled} OPTIONAL, |
| enableDefaultBeamPL-ForSRS-r16 | ENUMERATED {enabled} OPTIONAL, |
| enableMultipleDefaultBeamsPLs-ForPUCCH | ENUMERATED {enabled} |
| OPTIONAL, | |
| ]] | |
| } | |

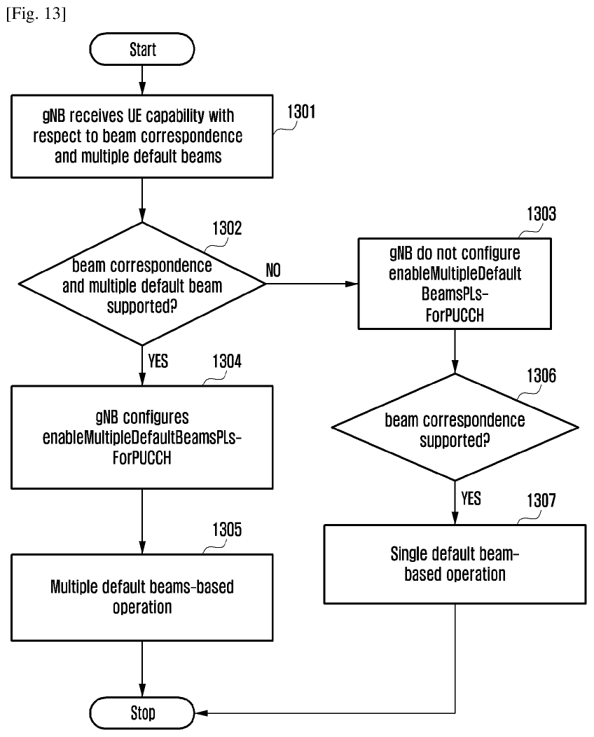

FIG. 13 illustrates a flowchart for the gNB-side process of acquiring a default beam and PLRS for the transmission of PUCCH in the disclosed embodiments.

FIG. 13 presents the flow chart for operations pertaining to PUCCH default beams from the gNBs perspective. Upon reception of UE's capability report with respect to beam correspondence and support for multiple default beams (1301), the gNB decides whether to configure enableMultipleDefaultBeamsPLs-ForPUCCH or not. If the UE supports beam correspondence and multiple default beams (1302), then the gNB configures the UE with enableMultipleDefaultBeamsPLs-ForPUCCH via RRC configuration (1304). Otherwise, the gNB do not configure enableMultipleDefault-BeamsPLs-ForPUCCH (1303). Moreover, if only beam correspondence is supported (1306), then a single default beam-based operations are conducted (1307). On the other hand, if both beam correspondence and multiple default beams are supported, then the gNB configures enableMultipleDefaultBeamsPLs-ForPUCCH (1304) and undertake multiple default-beams based operations according to the conditions detailed in the subsequent sections (1305).

The below sections discuss multiple scenarios. Two PDCCH Schemes are considered namely single frequency network (SFN) scheme and Non-SFN scheme. Multiple solutions are discussed for the default beam assumption and default pathloss reference signal assumption, of which one or more solutions are applicable to a given scenario. Conditions and solutions for each scenario described below can be combined with each other. In an embodiment of the disclosure, a parameter indicating whether default beam or default pathloss reference signal is enabled is described as a same one parameter, each of the default beam and default pathloss reference signal may be enabled using separate parameter. In an embodiment of the disclosure, a parameter indicating whether multiple (e.g. two) default beam or multiple (e.g. two) default pathloss reference signal is enabled is described as a same one parameter, each of the multiple default beam and multiple default pathloss reference signal may be enabled using separate parameter.

In the following a single beam-based solutions are presented for default PL-RS. Single beam based solutions are the simplest form of solutions where they can be considered as an extension to the existing solution in Rel. 16 NR. Therefore, the main aim of single beam-based solution is to solve issue-1 in Section 1.3, i.e., the ambiguity between selecting from multiple TCI states for PUCCH default beam (PL-RS and spatial setting).

Therefore, the following 4 condition in Rel. 16 are also considered while adding one more condition based on the availability of multiple TCI states activated by MAC-CE. The conditions described below are for illustrative purpose, and not all conditions have to be satisfied for using the solutions

The conditions for applying embodiments 1.1-4 are given as follows:
Condition I.1.1: the UE is not provided pathlossReferenceRSs, and
Condition I.1.2: the UE is not provided PUCCH-SpatialRelationInfo, and
Condition I.1.3: the UE is provided enableDefaultBeamPL-ForPUCCH-r16, and not provided enableMultipleDefaultBeamsPLs-ForPUCCH
Condition I.1.4: the UE is not provided coresetPoolIndex value of 1 for any CORESET, or is provided coresetPoolIndex value of 1 for all CORESETs, in ControlResourceSet and no codepoint of a TCI field, if any, in a DCI format of any search space set maps to two TCI states [5, TS 38.212]

A. SFNed PDCCH Scheme
Condition I.1.5: the UE is provided with at least one CORESET with multiple TCI states activated using MAC-CE command

the UE determines a RS resource index q_{d} providing a periodic RS resource with ‘QCL-TypeD’ in . . .

Spatial relation with respect to single TCI:
Solution I.1.1: the TCI state or the QCL assumption of the lowest TCI state ID activated for a CORESET with the lowest index
Solution I.1.2: the TCI state or the QCL assumption of the highest TCI state ID activated for a CORESET with the lowest index
Solution I.1.3: the TCI state or the QCL assumption of the first TCI state ID activated for a CORESET with the lowest index
Solution I.1.4: the TCI state or the QCL assumption of the last TCI state ID activated for a CORESET with the lowest index
Solution I.2: the TCI state or the QCL assumption of a CORESET with the lowest index, activated with a single TCI state using MAC CE command

Spatial relation with respect to multiple TCI:
Solution I.3: the QCL assumption of a CORESET with the lowest index, where the QCL assumption is a combination of all the TCI states activated for the CORESET using MAC CE command

B. Non-SFNed PDCCH Scheme

B.1. Single CORESETPoolIndex

When Condition I.1.1 to Condition I.1.4 are fulfilled the UE determines a RS resource index q_{d} providing a periodic RS resource with ‘QCL-TypeD’ in . . .
Solution I.4: the TCI state or the QCL assumption of a CORESET with the lowest index

In the following multiple default beams-based solutions are presented for default PL-RS. Multiple default beams-based solution allow PL computation based on multiple PL-RSs for accurate PL compensation associated with PUCCH repetitions towards mTRP. Therefore, multiple default beam-based solutions solve both issue-1 and issue-2 in Section 1.3.

Here, the first 3 conditions in Rel. 16 are also considered while dropping the 4^{th} condition which precludes multiple beams for PUCCH repetitions towards mTRP. The conditions described below are for illustrative purpose, and not all conditions have to be satisfied for using the solutions

If the UE
Condition I.2.1: the UE is not provided pathlossReferenceRSs, and
Condition I.2.2: the UE is not provided PUCCH-SpatialRelationInfo, and
Condition I.2.3: the UE is provided enableDefaultBeamPL-ForPUCCH-r16 and enableMultipleDefaultBeamsPLs-ForPUCCH,

A. SFNed PDCCH Scheme
Condition I.2.4: the UE is provided with at least one CORESET with multiple TCI states activated using MAC-CE command

the UE determines a RS resource index q_{d} providing a periodic RS resource with ‘QCL-TypeD’ in . . .

Spatial relation with respect to multiple TCI per each PUCCH beam:

When Condition I.2.1 to Condition I.2.4 are fulfilled the UE determines a RS resource index q_{d} providing a periodic RS resource with ‘QCL-TypeD’ in . . .
Solution I.5: the corresponding QCL assumption of a CORESET with the lowest index, where the QCL assumption is set by linking the two TCI states, activated for the CORESET using MAC CE command, to two PUCCH repetition beams.
Solution I.5.1: Lowest and highest TCI state IDs are activated for the first and second beam (based on beam-repetition association pattern), respectively.
Solution I.5.2: First and last TCI states based on their ordinal position in the MAC-CE activation are activated for the first and second beam (based on beam-repetition association pattern), respectively.

B. Non-SFNed PDCCH Scheme

B.1. Single coresetPoolIndex Present

When Condition I.2.1 to Condition I.2.4 are fulfilled the UE determines a RS resource index q_{d} providing a periodic RS resource with ‘QCL-TypeD’ in . . .
Solution I.6: the corresponding QCL assumption of a CORESET with the lowest index, where the QCL assumption is set by linking the TCI states, activated for the CORESET using MAC CE command, to PUCCH repetition beams.
Solution I.6.1: TCI states in the first and last CORESETs carrying the repeated PDCCH are activated for the first and second beam (based on beam-repetition association pattern), respectively.
Solution I.6.2: TCI states in the lowest and highest frequency location of SSs for CORESETs carrying the repeated PDCCH are activated for the first and second beam (based on beam-repetition pattern), respectively.

B.2. Multiple coresetPoolIndex Present

When Condition I.2.1 to Condition I.2.4 are fulfilled the UE determines a RS resource index q_{d} providing a periodic RS resource with ‘QCL-TypeD’ in . . .
Solution I.7:the TCI state or the corresponding QCL assumption of a CORESET
Solution I.7.1: with the lowest index among CORESETs configured with the same coresetPoolIndex
Solution I.7.2: with the highest index among CORESETs configured with the same coresetPoolIndex

where the QCL assumptions are set by linking TCI states corresponding to coreset-PoolIndex 0 and 1 to the first and second beam (based on beam repetition pattern), respectively.

In the following a single beam-based solutions is presented for default spatial settings of PUCCH transmission. Similar to the previous section, a single beam based solution is first presented which the simplest form of solutions where it can be considered as an extension to the existing solution in Rel. 16 NR. Therefore, the main aim of single beam-based solution is to solve issue-1 in Section 1.3, i.e., the ambiguity between selecting from multiple TCI states for PUCCH default beam (spatial setting).

Therefore, the following 4 condition in Rel. 16 are also considered. The conditions described below are for illustrative purpose, and not all conditions have to be satisfied for using the solutions

If a UE
Condition II.1.1: the UE is not provided pathlossReferenceRSs in PUCCH-PowerControl,
Condition II.1.2: the UE is provided enableDefaultBeamPL-ForPUCCH-r16 and not provided enableMultipleDefaultBeamsPLs-ForPUCCH, and
Condition II.1.3: the UE is not provided PUCCH-SpatialRelationInfo, and
Condition II.1.4: the UE is not provided CORESETPoolIndex value of 1 for any CORESET, or is provided CORESETPoolIndex value of 1 for all CORESETs, in ControlResourceSet and no codepoint of a TCI field, if any, in a DCI format of any search space set maps to two TCI states [5, TS 38.212] in ControlResourceSet and no codepoint of a TCI field, if any, in a DCI format of any search space set maps to two TCI states [5, TS 38.212]

A. SFNed PDCCH Scheme
Condition II.1.5: the UE is provided with at least one CORESET with multiple TCI states activated using MAC-CE command

When Condition II.1.1 to Condition I.1.5 are fulfilled a spatial setting for a PUCCH transmission from the UE is same as a spatial setting of . . .

Spatial relation with respect to single TCI:
Solution II.1.1: corresponding to the lowest TCI state ID used for PDCCH receptions by the UE in the CORESET with the lowest ID
Solution II.1.2: corresponding to the highest TCI state ID used for PDCCH receptions by the UE in the CORESET with the lowest ID
Solution II.1.3: corresponding to the first TCI state ID activated by the MAC CE activation command, used for PDCCH receptions by the UE in the CORESET with the lowest ID
Solution II.1.4: corresponding to the last TCI state ID activated by the MAC CE activation command, used for PDCCH receptions by the UE in the CORESET with the lowest ID
Solution II.2: for PDCCH receptions by the UE in the CORESET with the lowest ID, activated with a single TCI state.

Spatial relation with respect to multiple TCI:
Solution II.3: for PDCCH receptions by the UE in the CORESET with the lowest ID, where the spatial setting for the CORESET is a combination of the QCL assumptions of all the TCI states activated for the CORESET.

B. Non-SFNed PDCCH Scheme

B.1. Single CORESETPoolIndex

When Condition II.1.1 to Condition II.1.4 are fulfilled a spatial setting for a PUCCH transmission from the UE is same as a spatial setting . . .
Solution II.4: in TCI state or QCL assumption of a CORESET with the lowest ID

In the following multiple default beams-based solutions are presented for default spatial settings. Multiple default beams-based solution allow beamformed PUCCH repetitions towards multiple TRPs. Therefore, multiple default beams-based solutions solve both issue-1 and issue-2 in Section 1.3.

Here, the first 3 conditions in Rel. 16 are also considered while dropping the 4^{th} condition which precludes multiple beams for PUCCH repetitions towards mTRP. The conditions described below are for illustrative purpose, and not all conditions have to be satisfied for using the solutions

If a UE
Condition II.2.1: the UE is not provided pathlossReferenceRSs in PUCCH-PowerControl,
Condition II.2.2: the UE is provided enableDefaultBeamPL-ForPUCCH-r16 and enableMultipleDefaultBeamsPLs-ForPUCCH, and
Condition II.2.3: the UE is not provided PUCCH-SpatialRelationInfo, a spatial setting for a PUCCH transmission from the UE is same as a spatial setting . . .

A. SFNed PDCCH Scheme
Condition II.2.4: the UE is provided with at least one CORESET with multiple TCI states activated using MAC-CE command

a spatial setting for a PUCCH transmission from the UE is same as a spatial setting of . . .

Spatial relation with respect to multiple TCI per each PUCCH beam:
Solution II 5: the corresponding QCL assumption of a CORESET with the lowest index, where the QCL assumption is set by linking the TCI states, activated for the CORESET using MAC CE command, to PUCCH beams.
Solution II.5.1: Lowest and highest TCI state IDs are activated for the first and second beam (based on beam-repetition association pattern), respectively.
Solution II.5.2: First and last TCI states based on their ordinal position in the MAC-CE activation are activated for the first and second beam (based on beam-repetition association pattern), respectively.

B. Non-SFNed PDCCH Scheme

B.1. Single coresetPoolIndex

When Condition II.2.1 to Condition II.2.3 are fulfilled a spatial setting for a PUCCH transmission from the UE is same as a spatial setting . . .

Solution II.6: the corresponding TCI state activated for a CORESET with the lowest index, where the QCL assumption is set by linking the TCI states, activated for the CORESET using MAC CE command, to PUCCH beams.
Solution II.6.1: First and Last TCI state in time domain are activated for the first and second beam (based on beam-repetition pattern), respectively.
Solution II.6.2: TCI state IDs in the lowest and highest frequency location of SSs are activated for the first and second beam (based on beam-repetition mapping pattern), respectively.

B.2. Multiple coresetPoolIndex

When Condition II.2.1 to Condition II.1.3 are fulfilled a spatial setting for a PUCCH transmission from the UE is same as a spatial setting with QCL assumption of a TCI activated for . . .
Solution II.7.1: a CORESET with the lowest index among CORESETs configured with the same coresetPoolIndex.
Solution II.7.2: a CORESET with the highest index among CORESETs configured with the same coresetPoolIndex.

where the QCL assumptions are set by linking TCI states corresponding to coreset-PoolIndex 0 and 1 to the first and second beam (based on beam repetition pattern), respectively.

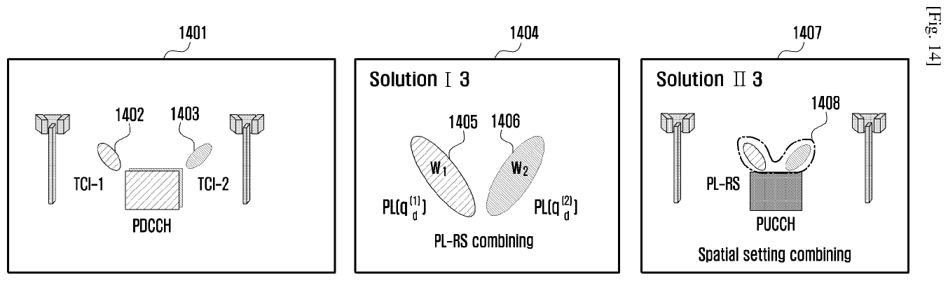

For Solution I.3, when PL is computed from a PL-RS obtained by combining the beam information (multiple TCI states) of PDCCH transmissions, the following could be considered. Without loss of generality let us consider two TRPs (beams) case while noting that the ideas below can be extended to any arbitrary number of TRPs. FIG. 14 illustrates an example of Solution I.3. The PDCCH received with two beams 1402 and 1403) in diagram 1401, is an SFNed PDCCH reception associated to two TCI states, i.e., TCI-1 and TCI-2. As shown in 1404, even if the PDCCH is transmitted by two beams, the PL can be computed by combining the PL measurement from PL-RSs while considering the two beams as one. Therefore, in Solution I.3 the PL computed by combining the two TCI states of the received PDCCH can be given as

PL_{b,f,c}(q_{d})=w₁PL_{b,f,c}(q_{d}⁹¹⁾)+w₂PL_{b,f,c}(q_{d}⁽²⁾) (2)

where q_{d}⁽¹⁾ and q_{d}⁽²⁾ are indices of periodic RS resources configured with TCI-1 and TCI-2 of the corresponding CORESET with lowest ID where the SFNed PDCCH are received. Moreover, w₁ and w₂ are a weighting factors to compute the weighted average of PLs corresponding to each beam.

Similarly, for Solution II.3 (1407), the transmission spatial setting for the corresponding PUCCH transmission can be selected by combining the two beams, with which the PDCCH is received, into one single beam (1408). After a UE estimates the PL from a PL-RS which is received by combining the QCL assumptions used to receive SFNed PDCCH transmission and the PL is computed with a corresponding weights (1405) and (1406), then the same weights can be employed to assign relative power to beam lobes of a beam formed for PUCCH repetitions with multiple beams in Solution I.3 (1408).

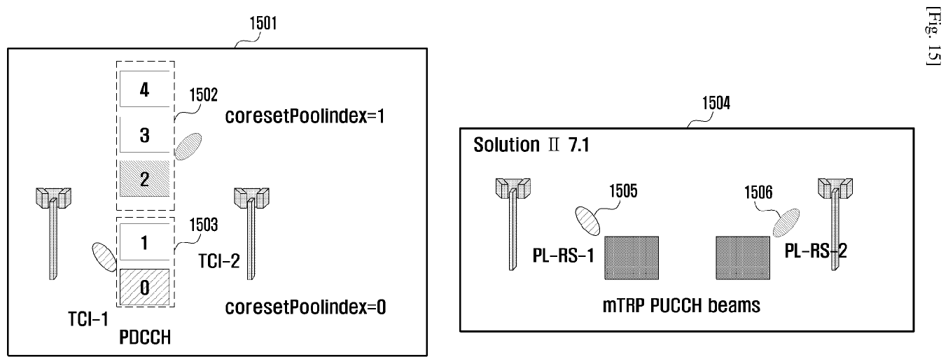

For Solution I.7 and Solution II.7, the case for multiple coresetPoolIndex is considered. In this case, the mTRP PDCCH transmission could be associated to multiple (two in Rel. 16 and 17 NR) CORESET pools. Then the corresponding multiple beams for PL-RS and transmission of PUCCH, could be derived from CORESETs associated with different coresetPoolIndex depending on the rules given in Solution I.7.1-7.2 and Solution II.7.1-7.2, respectively. FIG. 15 illustrates an example for Solution II.7.1. In this example, two PUCCH repetitions are transmitted based on two default beams (1505) and (1506) derived from the spatial settings with the same QCL assumption as the CORESETs with lowest ID in their respective pools, i.e., coresetPoolIndex=0 (1503) and coresetPoolIndex=1 (1502).

In Sections 2 and 3, the disclosed invention is presented for a special case wherein PDCCH is received from two TRPs in both SFNed and non-SFNed manner. Moreover, up to two default beams are considered for PUCCH transmission. This spatial case setting is aligned with the existing Rel. 16 NR and agreements for NR Rel. 17. However, this setting can be generalized to an arbitrary number of TRPs and PUCCH beams. Let the PDCCH is repeated from M TRPs in either SFN and non-SFN manner. Furthermore, let the L PUCCH repetitions are transmitted with N beams. The mapping between the N beams and L TRPs can be sequential or cyclic as discussed in Section 3.

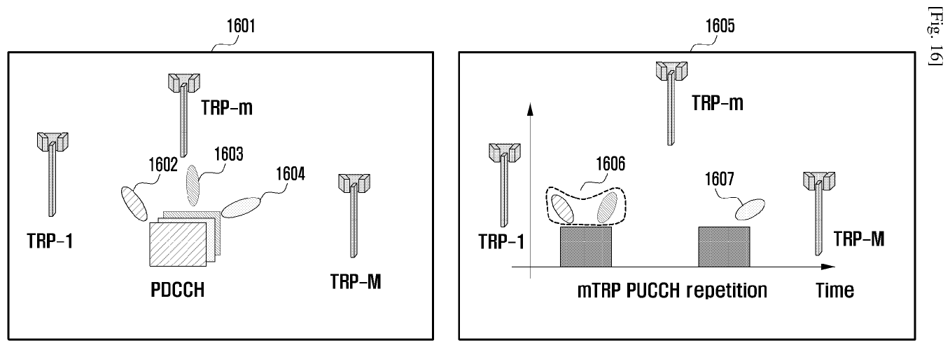

FIG. 16 illustrates an example for SFNed PDCCH repetition from M=3 TRPs and PUCCH repetitions with N=2 beams. In this example, the first default beam (1606) for PUCCH repetition is set by combining the spatial settings corresponding to beam-1 (1602) and beam-2 (1603). Consequently, it can be noticed that the combined beam (1606) is applied for both PL measurement as Solution I.3 and Solution II.3. This type arrangement can be particularly useful when transmission to multiple TRPs can be conducted by closely related beams.

Considering the above generalization of mTRP environment setting, the wording in the Solutions for multiple default beam considerations can be modified as follows:
For Solution I.5.1 and Solution II.5.1 the wording “Lowest and highest TCI state IDs are activated for the first and second beam (based on beam-repetition mapping pattern), respectively.” can be replaced by “Ascending order of N TCI states IDs starting from the lowest ID are activated for the N beams (based on beam-repetition mapping pattern), respectively.”
For Solution I.5.2 and Solution II.5.2 the wording “First and last TCI states based on ordinal position in the MAC-CE activation are activated for the first and second beam (based on beam-repetition mapping pattern), respectively.” can be replaced by “The first N TCI states, based on their ordinal position in the MAC-CE activation, are activated for the iv beams (based on beam-repetition mapping pattern), respectively.”
For Solution I.6.1 and Solution II.6.1 the wording “TCI states in the first and last CORESETs carrying the repeated PDCCH are activated for the first and second beam (based on beam-repetition mapping pattern), respectively.” can be replaced by “TCI states in the first N CORESETs carrying the repeated PDCCH are activated for the N beams (based on beam-repetition mapping pattern), respectively.”
For Solution I.6.2 and Solution II.6.2 the wording “TCI states in the first and last CORESETs carrying the repeated PDCCH are activated for the first and second beam (based on beam-repetition association pattern), respectively.” can be replaced by “TCI states in the first iv CORESETs carrying the repeated PDCCH are activated for the N beams (based on beam-repetition mapping association pattern), respectively.”
For Solution I.7.1, Solution I.7.2, Solution II.7.1 and Solution II.7.2 the wording “ where the QCL assumptions are set by linking TCI states corresponding to coreset-PoolIndex 0 and 1 to the first and second beam (based on beam repetition pattern), respectively. ” can be replaced by “where the QCL assumptions are set by linking TCI states corresponding to coresetPoolIndex 0 and N−1 to the first N beams (based on beam repetition pattern), respectively.”

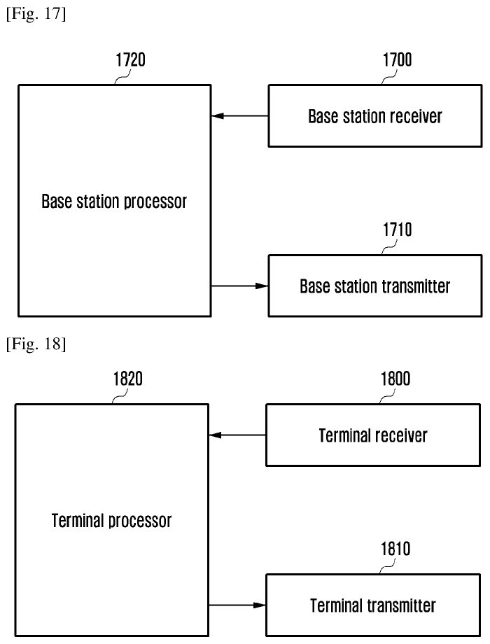

FIG. 17 is a block diagram illustrating a structure of a base station according to an embodiment of the disclosure.

As illustrated in FIG. 17, the base station of the disclosure may include a base station receiver 1700, a base station transmitter 1710, and a base station processor 1720. The base station receiver 1700 and the base station transmitter 1710 may be collectively called a “transceiver” in an embodiment of the disclosure. The transceiver may transmit or receive a signal to or from the terminal. The signal may include control information and data. To this end, the transceiver may include a radio frequency (RF) transmitter configured to up-convert and amplify a frequency of a signal to be transmitted, and an RF receiver configured to low-noise amplify a received signal and down-convert a frequency. In addition, the transceiver may receive a signal via a wireless channel, may output the signal to the base station processor 1720, and may transmit, via the wireless channel, a signal output from the base station processor 1720. The base station processor 1720 may control a series of processes to make the base station operate according to the above-described embodiment of the disclosure. For example, the base station processor 1720 may perform a channel access procedure with respect to an unlicensed band. For a more detailed example, the base station receiver 1700 may receive signals transmitted via the unlicensed band, and the base station processor 1720 may determine whether the unlicensed band is in an idle state by comparing a strength of each of the received signals with a threshold value that is pre-defined or is determined as a result value of a function using a bandwidth as a factor. In this case, the base station processor 1720 may perform a channel access procedure for each direction (or beam).

FIG. 18 is a block diagram illustrating a structure of a terminal according to an embodiment of the disclosure.

As illustrated in FIG. 18, the terminal of the disclosure may include a terminal receiver 1800, a terminal transmitter 1810, and a terminal processor 1820. The terminal receiver 1800 and the terminal transmitter 1810 may be collectively called a “transceiver” in an embodiment of the disclosure. The transceiver may transmit or receive a signal to or from the base station. The signal may include control information and data. To this end, the transceiver may include a radio frequency (RF) transmitter configured to up-convert and amplify a frequency of a signal to be transmitted, and an RF receiver configured to low-noise amplify a received signal and down-convert a frequency. In addition, the transceiver may receive a signal via a wireless channel, may output the signal to the terminal processor 1820, and may transmit, via the wireless channel, a signal output from the terminal processor 1820. The terminal processor 1820 may control a series of processes to make the terminal operate according to the above-described embodiment of the disclosure. For example, the terminal receiver 1800 may receive a data signal including a control signal, and the terminal processor 1820 may determine, based on a reception result of the control signal, uplink signal transmission and a channel access procedure scheme. Later, the terminal transmitter 1810 may transmit an uplink data signal to the base station.

Methods disclosed in the claims and/or methods according to various embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a ROM, an electrically erasable programmable read only memory (EEPROM), a magnetic disc storage device, a compact disc-ROM (CD-ROM), DVDs, or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks, such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein based on without departing from the spirit and scope of the disclosure as defined by the appended claims and their equivalents. Further, the above respective embodiments may be employed in combination, as necessary. For example, one embodiment of the disclosure may be partially combined with another embodiment to operate a base station and a terminal. Further, embodiments of the disclosure may be applied to other communication systems, and other variants may also be implemented based on the technical idea of the embodiments of the disclosure, For example, the embodiments may be applied to LTE, 5G, or NR systems.

1. A terminal in a communication system, the terminal comprising:
a transceiver; and
a controller configured to:
receive, from a base station, a higher layer parameter enabling a default beam and a default pathloss reference signal (RS) for a physical uplink control channel (PUCCH),
identify a spatial relation for the PUCCH,
transmit, to the base station, the PUCCH based on the spatial relation,
wherein the spatial relation for the PUCCH is associated with a transmission configuration indication (TCI) state of a control resource set (CORESET) with the lowest ID on an active downlink (DL) BWP, and
wherein, in case that the CORESET corresponds to more than one activated TCI state, the spatial relation for the PUCCH is associated with a first TCI state among the more than one activated TCI state.

2. The terminal of claim 1, wherein the controller is configured to identify a pathloss RS index used to determine power for the PUCCH,
wherein the pathloss RS index is associated with the TCI state of the CORESET with the lowest ID on an active DL BWP, and
wherein, in case that the CORESET corresponds to more than one activated TCI state, the pathloss RS index is associated with the first TCI state among the more than one activated TCI state.

3. The terminal of claim 1, wherein a value of CORESET pool index does not corresponds to 1 for any CORESET, or the value of CORESET pool index corresponds to 1 for all CORESETs.

4. The terminal of claim 1, wherein a dedicated pathloss RS for the PUCCH and a dedicated spatial relation for the PUCCH are not configured from the base station.

5. A method performed by a terminal in a communication system, the method comprising:
receiving, from a base station, a higher layer parameter enabling a default beam and a default pathloss reference signal (RS) for a physical uplink control channel (PUCCH),
identifying a spatial relation for the PUCCH,
transmitting, to the base station, the PUCCH based on the spatial relation,
wherein the spatial relation for the PUCCH is associated with a transmission configuration indication (TCI) state of a control resource set (CORESET) with the lowest ID on an active downlink (DL) BWP, and
wherein, in case that the CORESET corresponds to more than one activated TCI state, the spatial relation for the PUCCH is associated with a first TCI state among the more than one activated TCI state.

6. The method of claim 5, further comprising identifying a pathloss RS index used to determine power for the PUCCH,
wherein the pathloss RS index is associated with the TCI state of the CORESET with the lowest ID on an active DL BWP, and
wherein, in case that the CORESET corresponds to more than one activated TCI state, the pathloss RS index is associated with the first TCI state among the more than one activated TCI state.

7. The method of claim 5, wherein a value of CORESET pool index does not corresponds to 1 for any CORESET, or the value of CORESET pool index corresponds to 1 for all CORESETs.

8. The method of claim 5, wherein a dedicated pathloss RS for the PUCCH and a dedicated spatial relation for the PUCCH are not configured from the base station.

9. A base station in a communication system, the base station comprising:
a transceiver; and
a controller configured to:
transmit, to a terminal, a higher layer parameter enabling a default beam and a default pathloss reference signal (RS) for a physical uplink control channel (PUCCH), and
receive, from the terminal, the PUCCH based on a spatial relation for the PUCCH,
wherein the spatial relation for the PUCCH is associated with a transmission configuration indication (TCI) state of a control resource set (CORESET) with the lowest ID on an active downlink (DL) BWP, and
wherein, in case that the CORESET corresponds to more than one activated TCI state, the spatial relation for the PUCCH is associated with a first TCI state among the more than one activated TCI state.

10. The base station of claim 9, wherein power for the PUCCH is based on a pathloss RS index,
wherein the pathloss RS index is associated with the TCI state of the CORESET with the lowest ID on an active DL BWP, and
wherein, in case that the CORESET corresponds to more than one activated TCI state, the pathloss RS index is associated with the first TCI state among the more than one activated TCI state.

11. The base station of claim 9, wherein a value of CORESET pool index does not corresponds to 1 for any CORESET, or the value of CORESET pool index corresponds to 1 for all CORESETs.

12. The base station of claim 9, wherein a dedicated pathloss RS for the PUCCH and a dedicated spatial relation for the PUCCH are not configured to the terminal.

13. A method performed by a base station in a communication system, the method comprising:
transmitting, to a terminal, a higher layer parameter enabling a default beam and a default pathloss reference signal (RS) for a physical uplink control channel (PUCCH), and
receiving, from the terminal, the PUCCH based on a spatial relation for the PUCCH,
wherein the spatial relation for the PUCCH is associated with a transmission configuration indication (TCI) state of a control resource set (CORESET) with the lowest ID on an active downlink (DL) BWP, and
wherein, in case that the CORESET corresponds to more than one activated TCI state, the spatial relation for the PUCCH is associated with a first TCI state among the more than one activated TCI state.

14. The method of claim 13, wherein power for the PUCCH is based on a pathloss RS index,
wherein the pathloss RS index is associated with the TCI state of the CORESET with the lowest ID on an active DL BWP, and
wherein, in case that the CORESET corresponds to more than one activated TCI state, the pathloss RS index is associated with the first TCI state among the more than one activated TCI state.

15. The method of claim 13, wherein a value of CORESET pool index does not corresponds to 1 for any CORESET, or the value of CORESET pool index corresponds to 1 for all CORESETs.
